(19) United States
(12) Patent Application Publication
(10) Pub. No.: US 2024/0134961 A1
(43) Pub. Date: Apr. 25, 2024

(54) METHODS AND SYSTEMS THAT MONITOR SYSTEM-CALL-INTEGRITY

(71) Applicant: VMware, Inc, Palo Aito, CA (US)

(72) Inventors: Sachin Shinde, Maharashtra (IN); Shirish Vijayvargiya, Maharashtra (IN); Amardeep Nagarkar, Maharashtra (IN); Sunil Hasbe, Maharashtra (IN)

(73) Assignee: VMware, Inc, Palo Alto, CA (US)

(21) Appl. No.: 17/970,168

(22) Filed: Oct. 19, 2022

(51) Int. Cl. G06F 21/52; G06F 21/57

(52) U.S. Cl. CPC G06F 21/52; G06F 21/57

(57) ABSTRACT

The current document is directed to automated methods and systems that monitor system-call execution by operating systems in order to detect operating-system corruption. A disclosed implementation of the currently disclosed automated system-call-integrity monitor generate operational system-call fingerprints for randomly selected system calls executed by guest operating systems of randomly selected virtual machines and compares the operational system-call fingerprints to reference system-call fingerprints in order to detect operational anomalies of guest operating systems that are likely to represent guest-operating-system corruption. In disclosed implementations, a system-call fingerprint includes a system-call execution time, the number of instructions executed during execution of the system call, and a snapshot of the call stack taken during execution of the system call. The currently disclosed methods and systems can be used to monitor the system-call integrity of discrete computer systems, including personal computers, as well as computer-system clusters and aggregations.

### TECHNICAL FIELD

The current document is directed to distributed-computer-system integrity and, in particular, to methods and systems that monitor system-call execution by operating systems in order to detect operating-system corruption.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computer systems with hundreds of thousands, millions, or more components that provide enormous computational bandwidths and data-storage capacities. These large, distributed computer systems are made possible by advances in computer networking, distributed operating systems and applications, data-storage appliances, computer hardware, and software technologies. Despite all of these advances, however, the rapid increase in the size and complexity of computing systems has been accompanied by numerous scaling issues and technical challenges, including technical challenges associated with communications overheads encountered in parallelizing computational tasks among multiple processors, component failures, detecting and ameliorating security breaches, and distributed-system management. Developers, managers, owners, and users of distributed computer systems therefore continue to seek improved management and security methods to address the many technical challenges associated with distributed computer systems, particularly automated management and security methods increasingly necessary for managing these technical challenges in ever more complex and large distributed computer systems.

### SUMMARY

The current document is directed to automated methods and systems that monitor system-call execution by operating systems in order to detect operating-system corruption. A disclosed implementation of the currently disclosed automated system-call-integrity monitor generate operational system-call fingerprints for randomly selected system calls executed by guest operating systems of randomly selected virtual machines and compares the operational system-call fingerprints to reference system-call fingerprints in order to detect operational anomalies of guest operating systems that are likely to represent guest-operating-system corruption. In disclosed implementations, a system-call fingerprint includes a system-call execution time, the number of instructions executed during execution of the system call, and a snapshot of the call stack taken during execution of the system call. The currently disclosed methods and systems can be used to monitor the system-call integrity of discrete computer systems, including personal computers, as well as computer-system clusters and aggregations.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates time-division-multiplexing of program execution by an operating system.

FIG. 12 illustrates certain of the fundamental computational resources provided by a processor.

FIG. 13 illustrates a call stack that is used by a process for keeping track of the sequence of routines currently executing within the processor on behalf of the process as well as for temporary data storage.

FIGS. 14A-D illustrate one implementation of virtual memory

FIGS. 15A-D illustrates system-call execution by an operating system and underlying hardware in response to a system call made by an application.

FIG. 16 illustrates, at a high level, one implementation of the currently disclosed automated system-call integrity-monitoring systems that monitor the system-call integrity of guest operating systems running in virtual machines of a distributed computer system in order to detect various types of corruptions and alterations of the system-call process carried out by the guest operating systems.

FIG. 17 shows a number of relational-database tables that are employed in control-flow diagrams, provided in FIGS. 18A-27, that illustrate one implementation of the currently disclosed automated system-call-integrity monitor.

FIGS. 18A-B show a control-flow diagram for a routine “OS Corruption Detector,” which represents one implementation of the detector portion of the currently disclosed automated system-call-integrity monitor.

FIGS. 19A-B shows control-flow diagrams for the routine “fingerprint agent,” called in step 1811 of FIG. 18A.

FIG. 20 provides a control-flow diagram for the routine “send SC request,” called in step 1832 of FIG. 18B.

FIG. 21 provides a control-flow diagram for the routine “verify response.” called in step 1840 of FIG. 18B.

FIG. 22 provides a control-flow diagram for the routine “verify stack” called in step 2114 of FIG. 21.

FIG. 23 shows a table time_data maintained by each system-call-integrity-monitor agent.

FIG. 24 provides a control-flow diagram for a routine “agent,” which represents the operation of each system-call-integrity-monitor agent.

FIG. 25 provides a control-flow diagram for the system-call-request handler called in step 2408 of FIG. 24.

FIGS. 26A-B provide control-flow diagrams for the system-call-fingerprint-request handler called in step 2412 of FIG. 24.

FIG. 27 provides a control-flow diagram for the routine “update tree” called in step 2624 of FIG. 26B.

### DETAILED DESCRIPTION

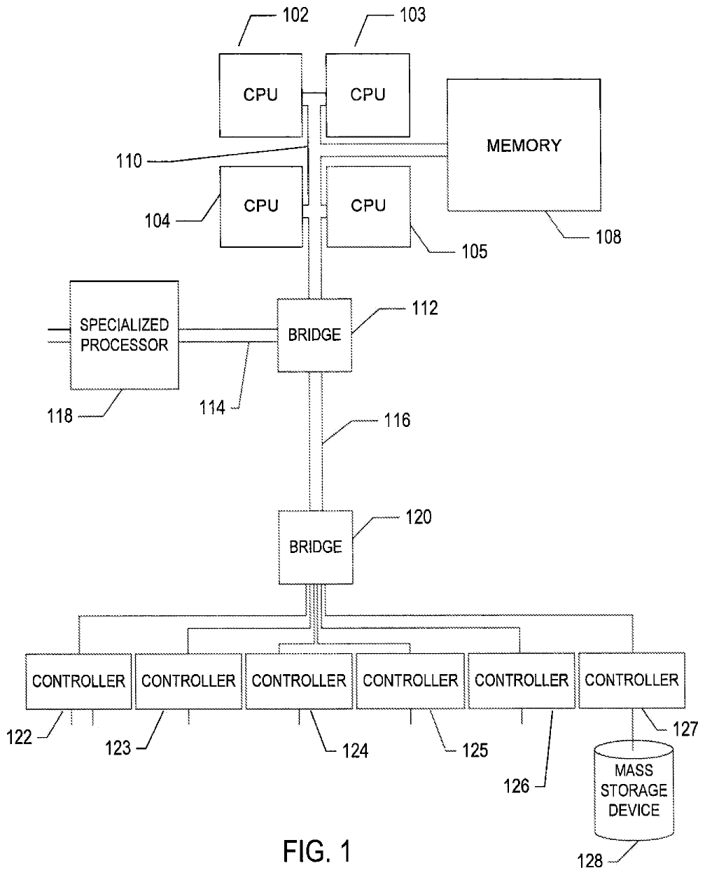

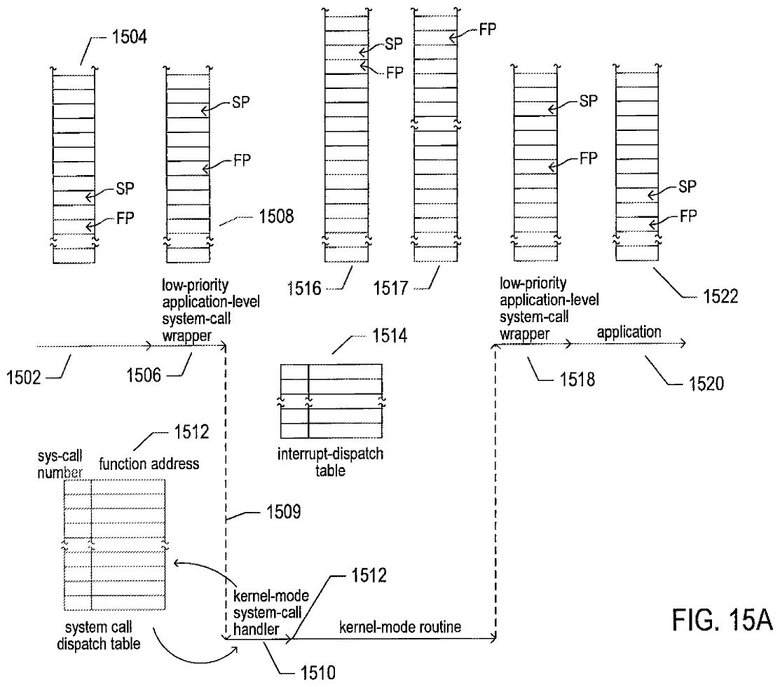

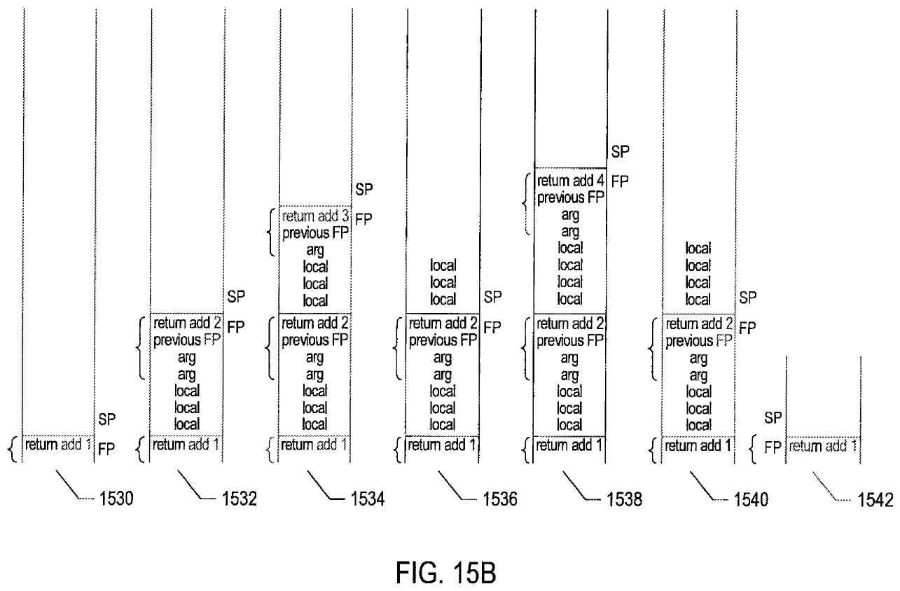

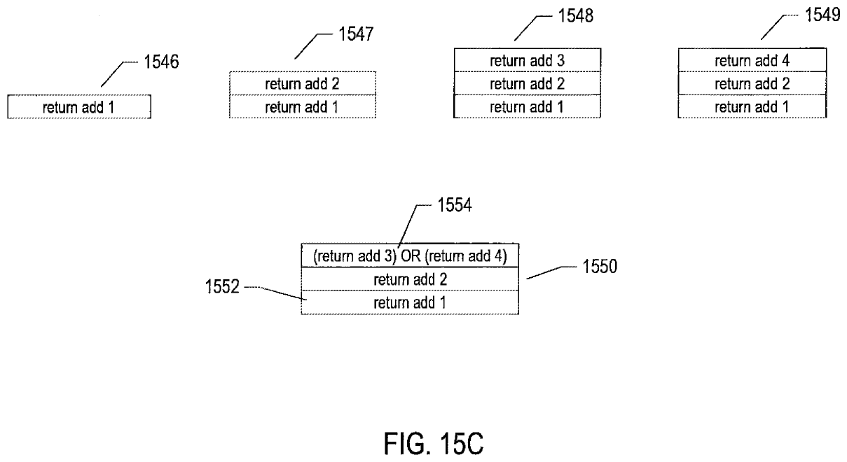

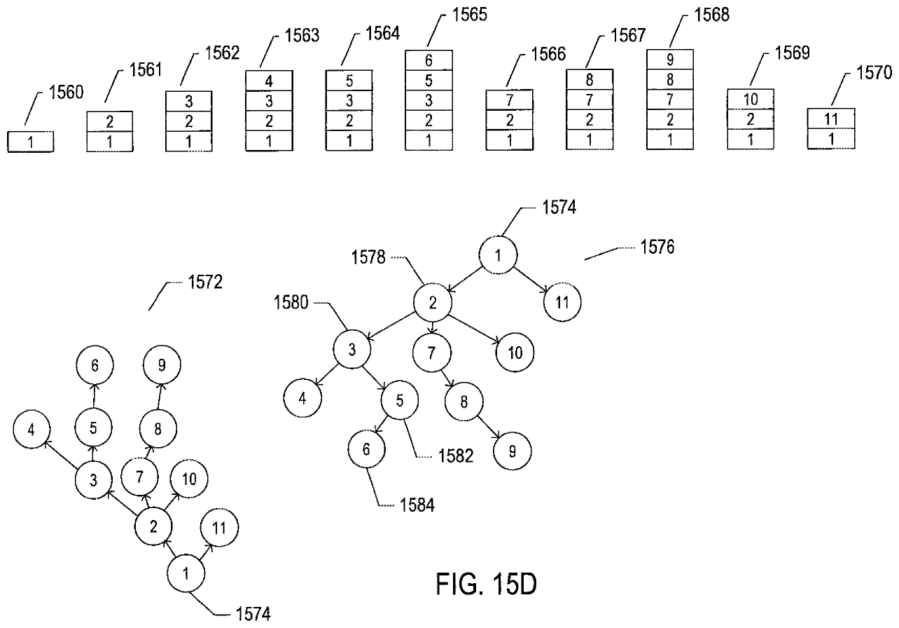

The current document is directed to methods and systems that monitor system-call execution by guest operating systems in order to detect guest-operating-system corruption. In a first subsection, below, a detailed description of computer hardware, complex computational systems, and virtualization is provided with reference to FIGS. 1-10. In a second subsection, an overview of processor architecture and operation is provided, with reference to FIGS. 11-14D. In a third subsection, the current disclosed methods and systems are discussed with reference to FIGS. 15A-27.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

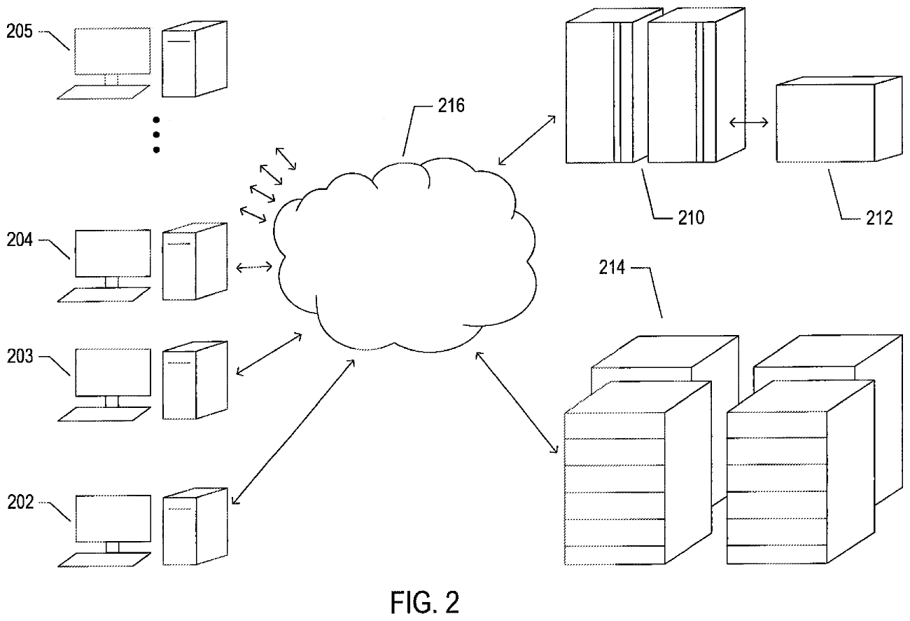

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

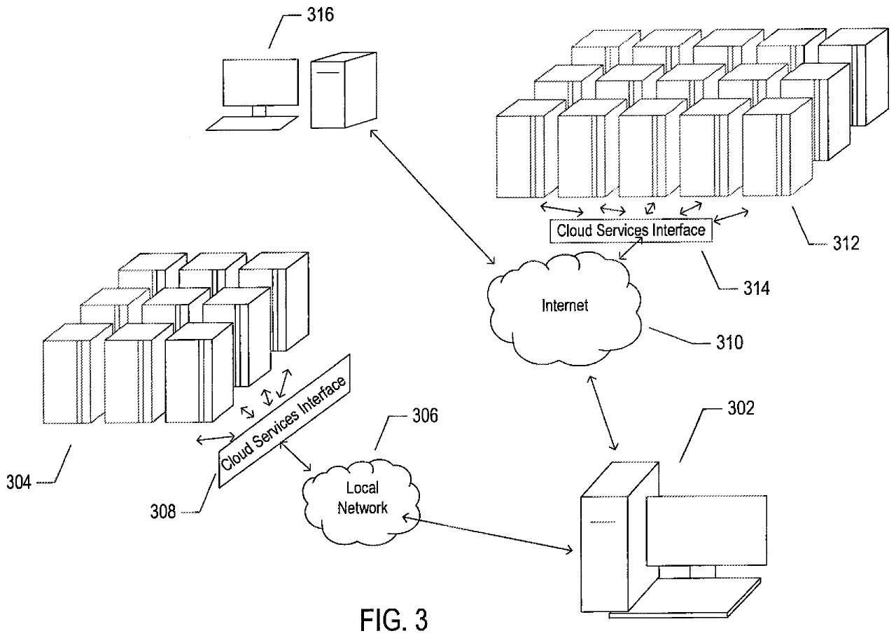

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

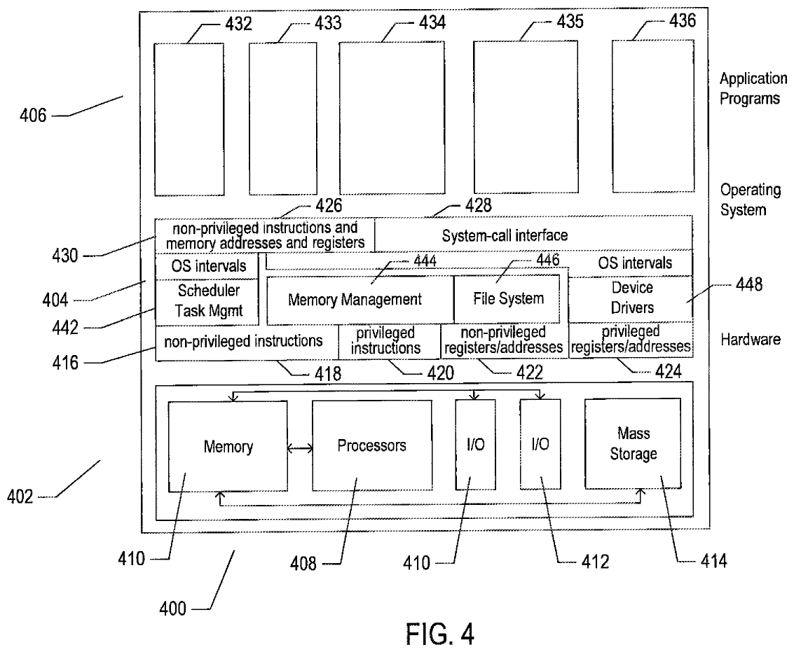

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

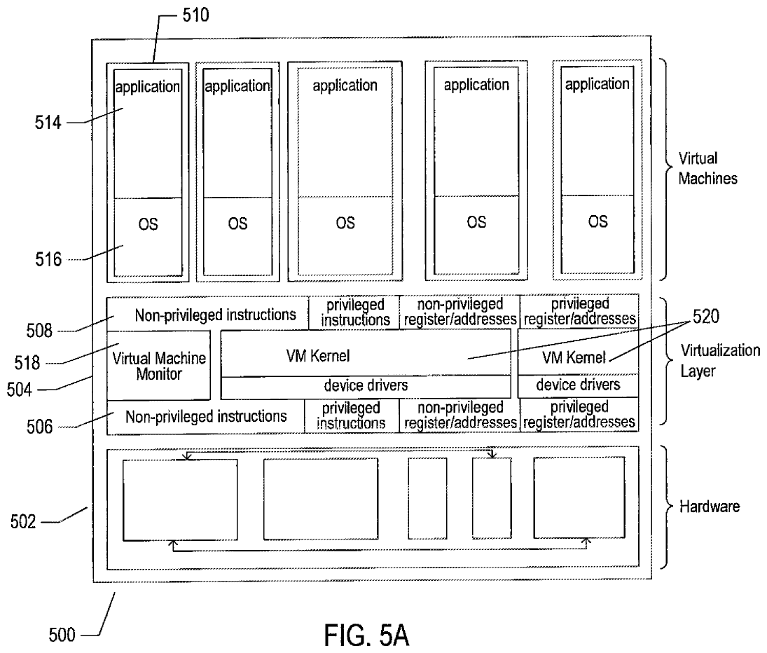

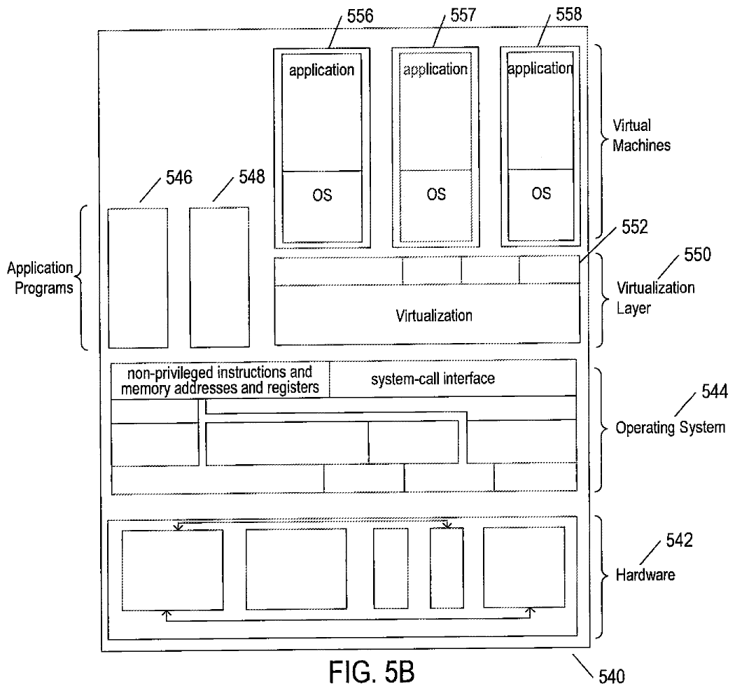

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such de, ices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

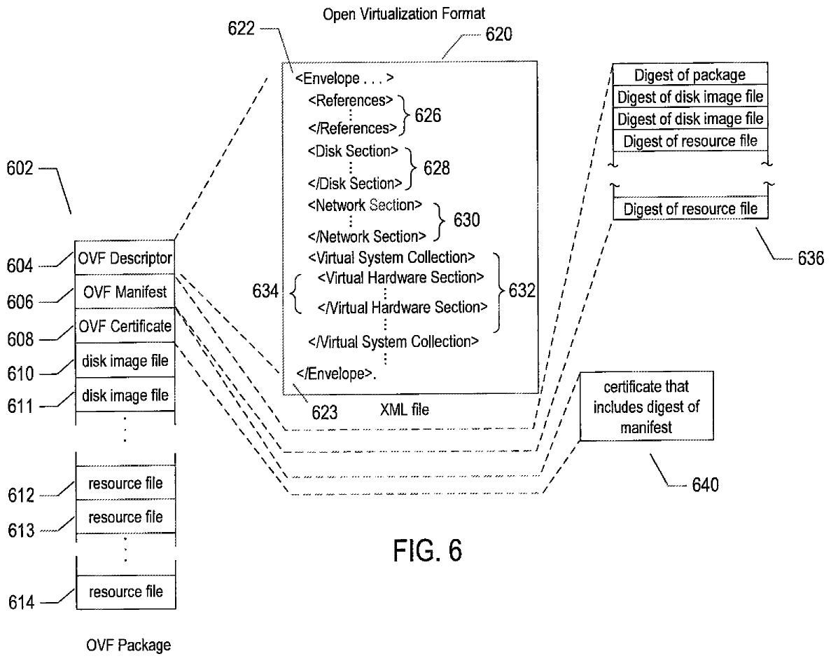

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an (VF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

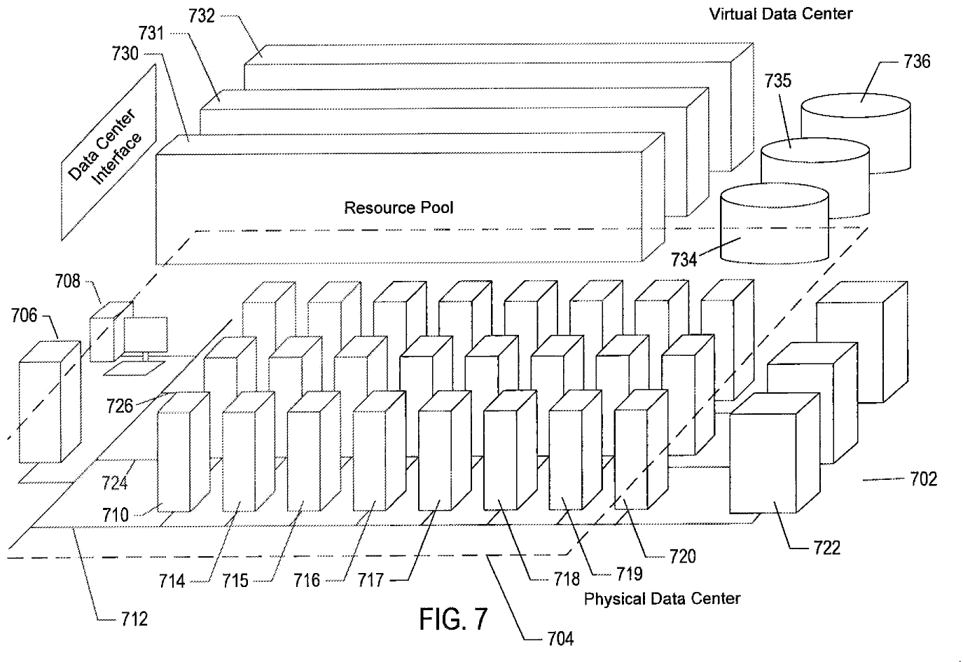

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provides a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

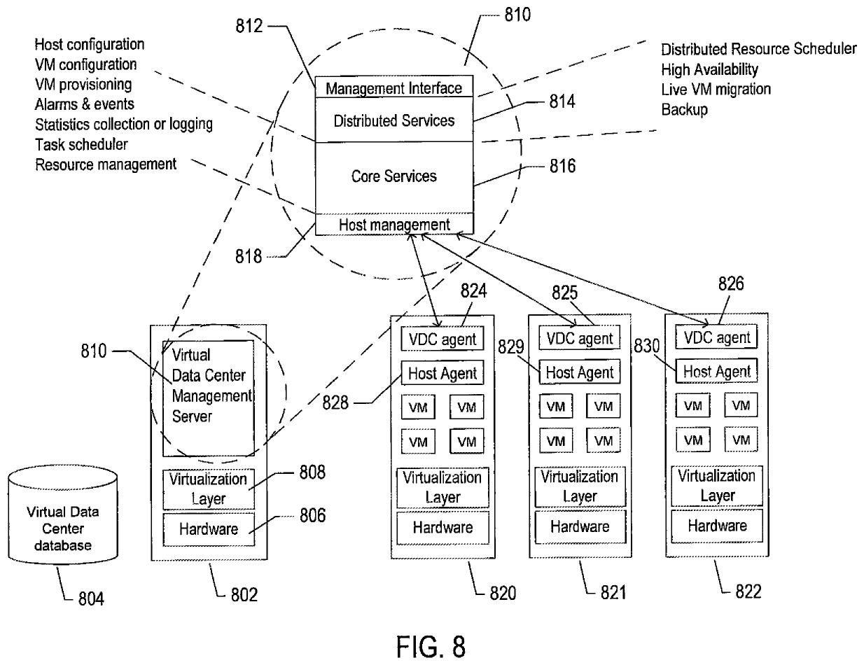

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

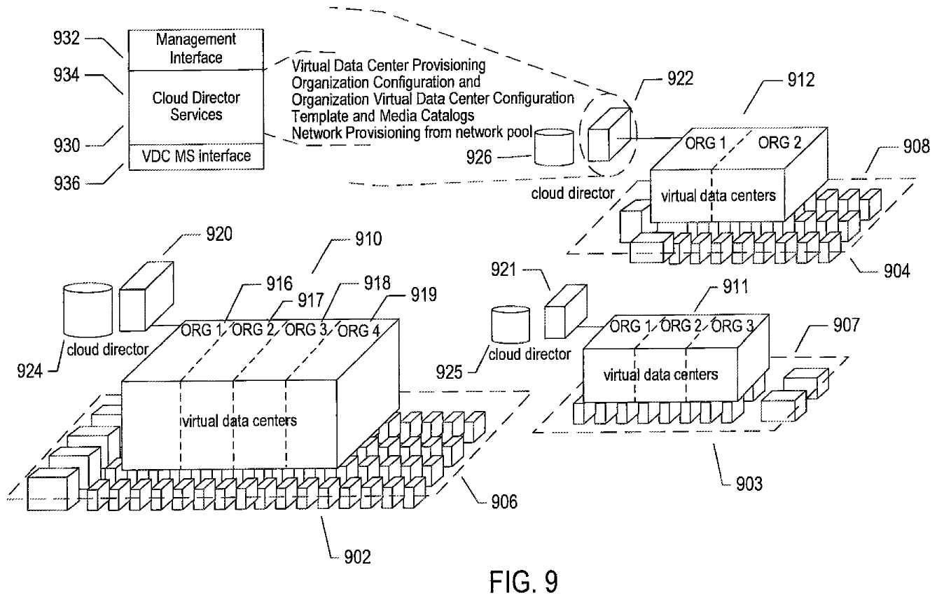

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

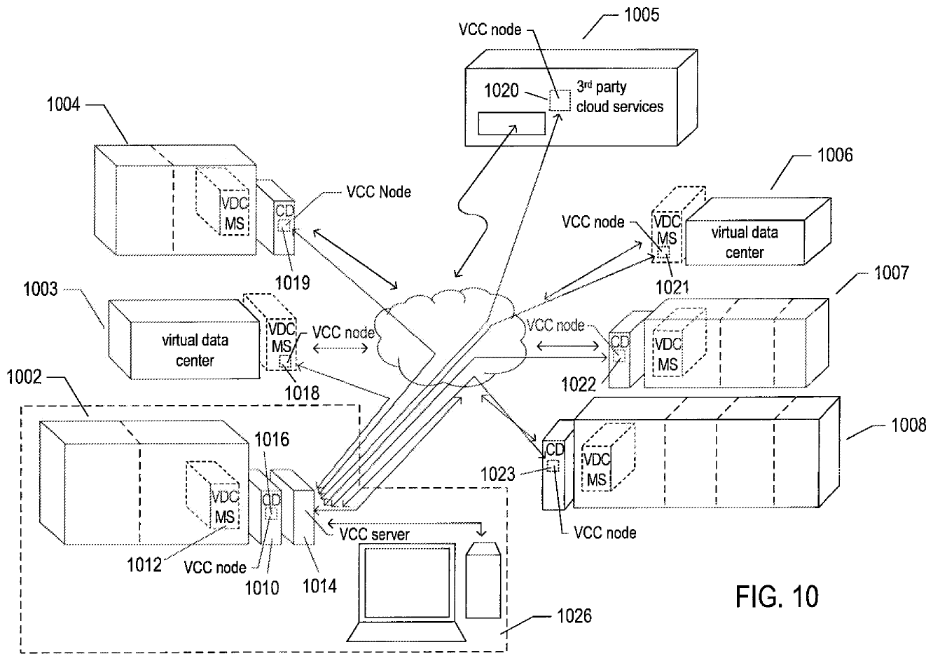

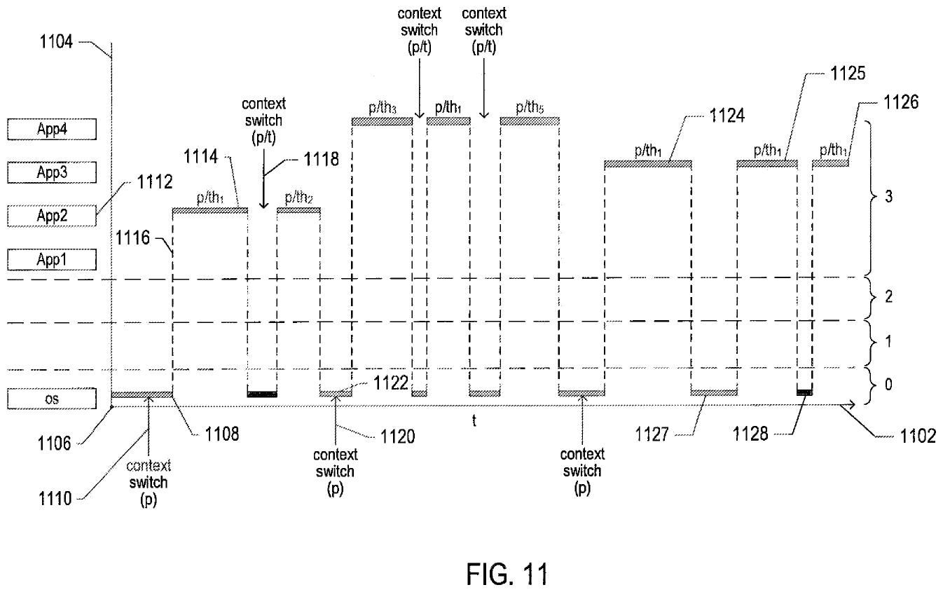

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Processor Architecture and Operation

FIG. 11 illustrates time-division-multiplexing of program execution by an operating system. FIG. 11 is a plot of process execution, with the horizontal axis 1102 representing time and the vertical axis 1104 representing the various programs executing within a computer system controlled by an operating system during the period of time represented by the horizontal time axis, including the operating system (“OS”) and application programs 1, 2, 3, and 4. The term “program” refers to the lowest-granularity executable entity corresponding to a logical computational entity such as an application program, an operating system, or virtualization layer. Each program, during execution, may comprise multiple executing processes, where a process is an operating-system-controlled entity associated with a processor-control block (“PCB”) data structure maintained by the operating system to which computational resources are allocated by the operating system. A process is the lowest-granularity executable entity that can be scheduled and managed by an operating system. Each process may, in turn, comprise multiple threads. In many operating systems, a thread is the highest-granularity executable managed by the operating system. Often, execution of an application program begins with the launching of one or a small number of processes. Each of these initial processes may subsequently spawn additional processes, as required, to handle dynamically evolving workloads and tasks. Each process is associated with its own virtual-memory address space, call stack, and state, as represented by the contents of various processor registers. The threads are essentially lightweight processes that run within the context of a process, sharing a single virtual-memory address space and certain other computational resources allocated to the process in the context of which they execute.

The origin 1106 of the time axis represents an arbitrary point in time. At this point in time, the operating system is executing, as represented by horizontal bar 1108. At a point in time represented by vertical arrow 1110, the operating system initiates a context switch that results in temporary discontinuation of execution of the operating system and resumption of execution of a process thread of application 2 (1112 in FIG. 11), as represented by horizontal bar 1114. Vertical dashed line segment 2116 thus represents a context switch from execution of the operating system to execution of application 2. At a point in time represented by vertical arrow 1118, there is a second context switch from one process/thread of application 2 to another process/thread of application 2. At a point in time represented by vertical arrow 1120, a context switch occurs that results in temporary termination of execution of application 2 and resumption of execution of application 4. These context switches involve a short period of time, such as the time interval represented by horizontal bar 1122, during which the operating system executes in order to carry out the context switch. Execution of a process/thread, such as execution of the process/thread represented by horizontal bars 1124-1126, may be interleaved by periods of execution of the operating system, as represented by horizontal bars 1127-1128. These periods of execution may represent handling of interrupts and execution of system calls made by the process/thread, which, in many modern operating systems and processor architectures, are not associated with context switches. Instead, the operating system briefly executes at a higher priority than the execution priority associated with application processes and threads, but in the same context of the application process that was executing when the interrupt of system call occurred.

The net result of time-division-multiplexing of program execution by an operating system is that the computational resources associated with a processor and other computer-system components are shared among multiple concurrently-executing programs, giving each program the illusion of executing alone in an isolated computer system. In modern computer systems, including desk-top computer systems and smart phones, there may be multiple processors that each contain multiple different processor cores, and modern operating systems generally use time-division multiplexing to concurrently run multiple different programs, processes, and/or threads on each core.

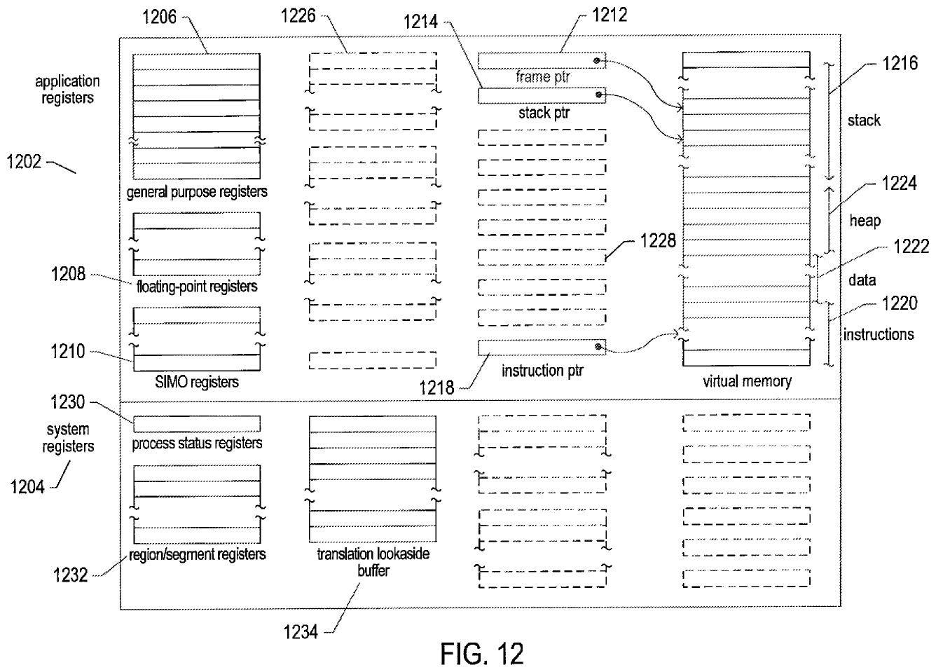

FIG. 12 illustrates certain of the fundamental computational resources provided by a processor. These resources are registers, high-speed memory within the processor, that together encapsulate the state of a process and of the processor, as a whole. In multi-core processors, each core includes a separate set of registers, but the multiple cores may share memory caches and other higher-level computational resources. The processor registers are divided into a set of application registers 1202 and a set of system registers 1204. The application registers include: (1) a set of general-purpose registers 1206 that are used for storing intermediate integer results and as operands for various instructions/operations; (2) a set of floating-point registers 1208 used for storing intermediate floating-point results and as operands for floating-point instructions/operations; (3) a set of single-instruction multiple-data registers (“SIMD” registers) 1210 used for parallel instructions that operate in parallel on multiple data values; (4) a frame-pointer register 1212 and a stack-pointer register 1214 that point to call frames and to the logical top of the call stack, respectively, where the call stack is, in many types of processor/operating systems, located in the high-address portion 1216 of a virtual-memory space allocated to a process; and (5) an instruction-pointer register 1218 and points to a next instruction for execution, where the instructions occupy a low-address portion 1220 of the virtual-memory address space, which further includes a data portion 1222 and a heap portion 1224. The call stack is often referred to simply as “the stack,” but the current discussion uses the phrase “call stack” to make it clear that it is the stack onto which call frames are pushed that is being referred to. The application registers include many additional registers represented in Figure by dashed-lined register sets 1226 an individual registers 1228. The system registers include a process status register 1230, which includes various different flags indicating various different aspects of the state of a process, a set of region/segment registers 1232, and a translation-lookaside buffer 1234. The system registers include many additional registers and register sets represented by dashed-line register sets and registers in FIG. 12. It is the contents of many of the registers that are stored in an operating-system PCB data structure in order to store the state of an executing process, used for restoring register values during a context switch that resumes execution of the process.

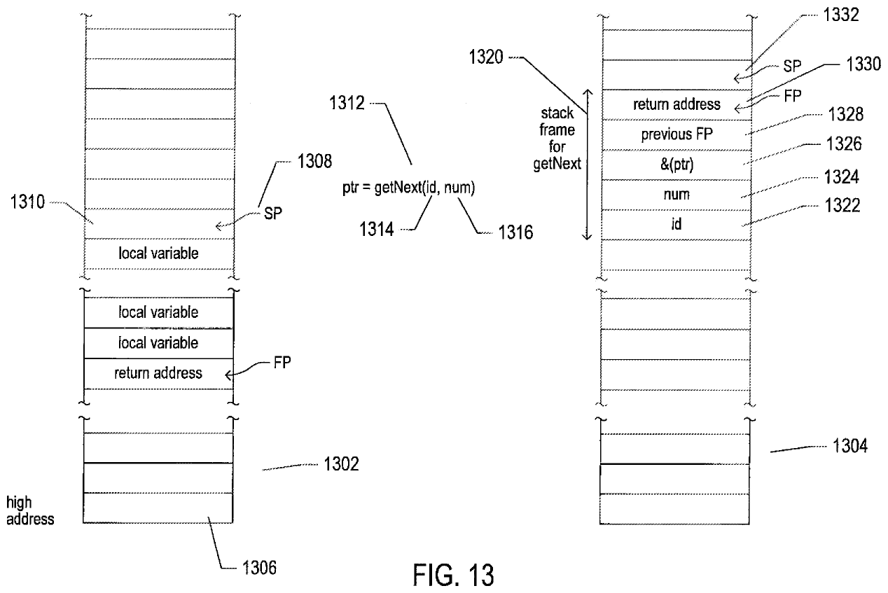

FIG. 13 illustrates a call stack that is used by a process for keeping track of the sequence of routines currently executing within the processor on behalf of the process as well as for temporary data storage. FIG. 13 shows two different snapshots of the contents of the call stack 1302 and 1304 at two different points in time. The call stack is shown as a vertical column of virtual-memory words beginning at a lowest word 1306 in the call stack, having the highest virtual-memory address, and extending upward to the first available word at the top of the call step referenced by a virtual-memory address in the stack-pointer register (“SP”) (1214 in FIG. 12). In FIG. 13, the contents of the SP register are shown to point 1308 to the next available word at the top of the call stack 1310. When a currently executing routine calls itself or another routine, the currently executing routine may push various data values on the call stack and then pushes calling arguments for the called routine onto the call stack followed by a return address, with the pushed calling arguments and return address constituting a call frame. The frame-pointer register (“FP”) (1212 in FIG. 12) points to the top of the most recent call frame pushed onto the stack. Snapshot 1302 illustrates the contents of a call stack prior to execution of a call, by the currently executing routine of a process or thread, to the routine “getNext” 1312. The routine “getNext” receives two arguments 1314 and 1316. Snapshot 1304 illustrates the contents of the call stack after the currently executing routine has pushed a next call frame onto the stack and the called routine “getNext” begins to execute. Double-headed arrow 1320 illustrates the pushed call frame. It includes the two calling arguments 1322 and 1324, the address of the variable that receives the output from the called routine 1326, the address of the previous call frame 1328, and the return address 1330 at which execution of the calling routine resumes following completion of execution of the called routine “getNext.” The stack pointer now points to the next available word of the top of the call stack 1332. When the called routine “getNext” completes, the call frame 1320 and any values pushed onto the call stack by the routine “getNext” are popped from the call stack by restoring the previous values of the SP and FP pointers. Execution of the calling routine resumes at the instruction at the top of the removed calling frame, restoring the contents of the stack to those shown in the first snapshot 1302. The call stack is thus used both for temporary data storage, such as the local variables of a routine, as well as for storing the sequence of call frames corresponding to the currently executing routines. The call stack is a significant portion of the state of a process or thread, in addition to the contents of various of the application registers and system registers.

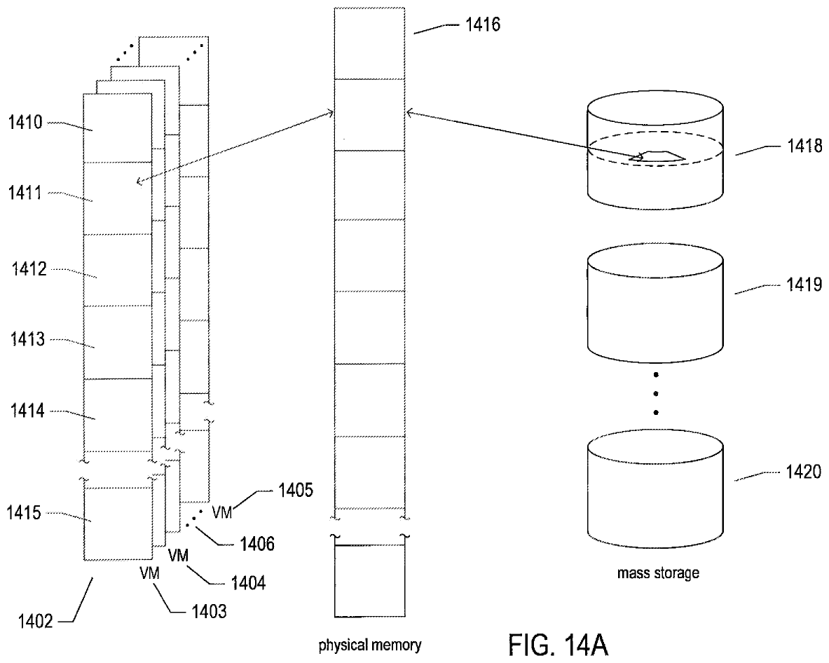

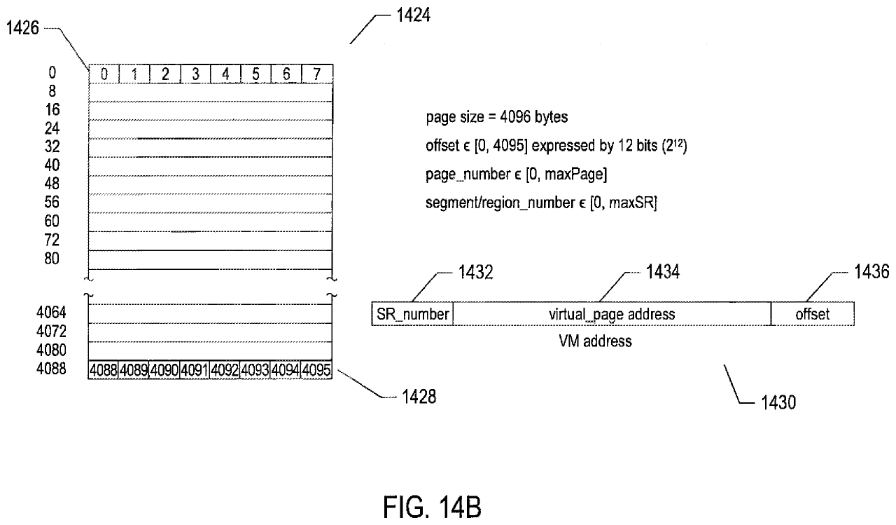

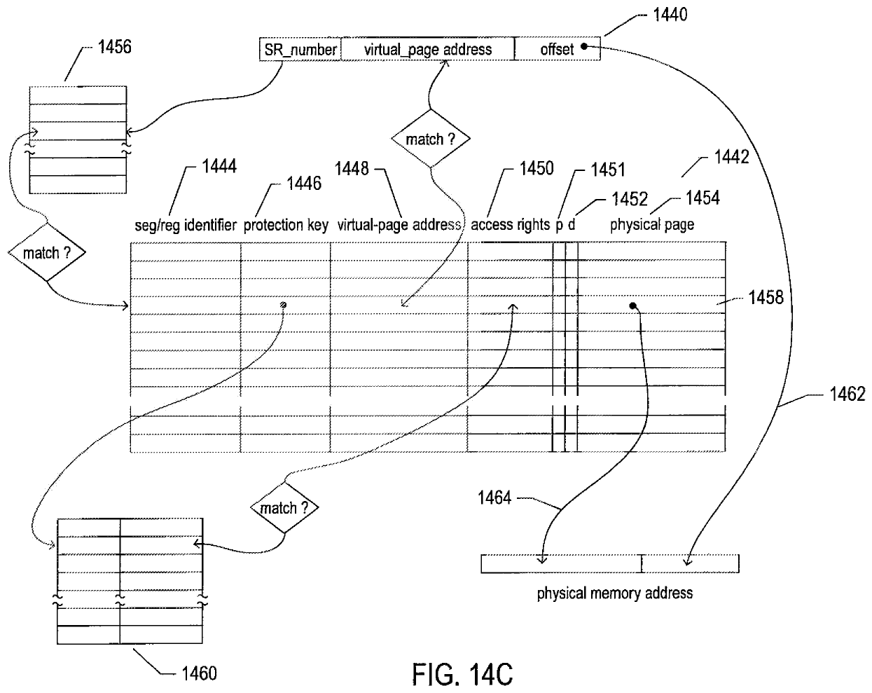

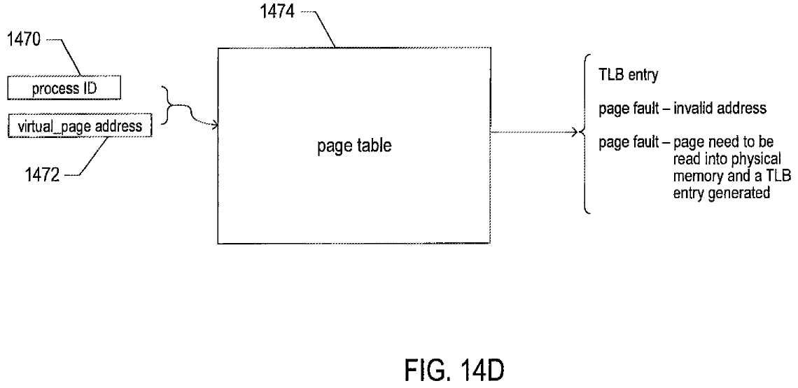

FIGS. 14A-D illustrate one implementation of virtual memory. As shown in FIG. 14A, each of the currently active processes supported by an operating system is allocated a virtual-memory address space 1402-1405, with ellipsis 1406 indicating additional virtual-memory address spaces. A virtual-memory address space, in many implementations, is a consecutive set of memory addresses that describe a large number of addressable words, such as 32-bit or 64-bit words. Processors generally support a natural word size, although certain processor architectures are designed to support two or more natural word sizes, depending on the operating system running on the processor. The virtual-memory address space is generally partitioned into a corresponding set of consecutive virtual-memory pages, such as virtual-memory pages 1410-1415 in virtual-memory address space 1402. An operating system, generally using instruction-set-architecture support of underlying hardware processors, maps the virtual-memory address spaces to physical memory 1416. Physical memory is also divided into pages. The physical memory address space is, in turn, backed up by pages stored within mass-storage devices 1418-1420. In general, only a very small number of the virtual-memory pages of a virtual-memory address space reside in physical memory at any given point in time. When a process attempts to access a virtual-memory address within a virtual-memory page that is not resident in physical memory, the virtual-memory page is paged into a physical-memory page by the operating system, using instruction-set-architecture support of underlying hardware processors. Because a generally tends to access only a small subset of the total number of virtual-memory pages that contain instructions and data for the process, the overheads associated with paging in virtual-memory pages from mass storage are usually minimal compared with the advantages of providing separate, isolated virtual-memory address spaces to the currently active processes supported by an operating system. Virtual memory is thus another method of multiplexing computational resources among executing processes similar to multiplexing of processor bandwidth among concurrently executing processes via time-division multiplexing.

As shown in FIG. 14B, a virtual-memory page 1424 is a set of successively addressed words. In the example shown in FIG. 14B, the virtual-memory page 1424 includes 512 64-bit words, each containing 8 bytes that are each separately addressable. The page address of the first byte in each word serves as the page address of the entire word. Thus, the first word 1426 in virtual-memory page 1424 has the page address 0 and the final word 1420 has the page address 4088. The virtual-memory page, in this example, thus includes 4096 bytes. The page addresses of these bytes are referred to as “offsets,” with the offset of any byte in the virtual-page expressible by a 12-bit offset. Each virtual-memory page may be associated with a page number in the range [0, maxPage−1], with the virtual-memory address space including maxPage virtual-memory pages. The address of a virtual-memory page in this example is equal to the page number multiplied by 4096. In many operating systems, virtual-memory address spaces are also divided into segments or regions, each segment or region containing a fixed number of virtual-memory pages. A virtual-memory address, in the present example, is composed of an offset or page address added to a virtual-page address, with the sum of the offset and virtual-page address added to a segment or region address. In the current example, the word size supported by the operating system and underlying hardware is 64 bits or eight bytes. A virtual-memory address 1430 is therefore a 64-bit quantity since natural words are generally used for storing virtual-memory addresses. In the current example, this 64-bit quantity includes a segment/region number field 1432, a virtual-page-address field 1434, and an offset field 1436. In the current example, the offset field has a length of 12 bits. The segment region-number field has a length sufficient to encode the maximum possible segment/region number, and the virtual-page-address field is then equal to 64-12—the length of the segment/region-number field. While, in this example, the virtual-memory address space has addresses for more than 1.8×10¹⁹ bytes or 2.3×10⁸ words, this does not mean that the operating system actually allocates this number of words to each process. In fact, processes are initially allocated a much smaller amount of memory and are generally allowed to increase their memory allocations dynamically up to some maximum amount of memory that is much smaller than the theoretical maximum amount of memory that can be supported by virtual-memory addresses.

FIG. 14C illustrates how a virtual-memory address is automatically mapped to a physical-memory address. A virtual-memory address 1440 is shown at the top of FIG. 14C. When the virtual-memory address is used as an operand for a load or store instruction by a process, the processor executing the load or store instruction attempts to find a virtual-memory-address translation for the virtual-memory address in a set of registers referred to as the 7 translation-lookaside buffer 1442. Each register, or entry, in the translation-lookaside buffer stores either a valid virtual-memory-address translation or is invalid. In one example type of processor, each translation-lookaside-buffer entry includes a segment/register identifier 1444, a protection key 1446, a virtual-page address 1448, an access-rights field 1450, a present bit 1451, a dirty bit 1452, and a physical-page address 1454. The processor uses the segment/region-field value of the virtual-memory address to find a segment/region identifier for the segment/region in a set of segment/region registers 1456. The processor then searches the translation-lookaside buffer for an entry that contains the segment/region identifier and that contains the virtual-page address corresponding to the virtual-page-address field of the virtual-memory address. In the example shown in FIG. 14C, entry 1458 includes field values that match the segment/region identifier and virtual-page address. The processor then checks to determine that the entry contains a valid translation, as indicated by the present bit 1451 and then uses the value of the protection-key field of the entry to find an encoding of a set of access rights corresponding to that protection-key-field value in another set of registers 1460. If the access rights corresponding to the protection-key-field value match the value in the access-rights field 1450 of the entry, the processor generates a physical-memory address corresponding to the virtual-memory address by using the value of the offset field in the virtual-memory address, as indicated by arrow 1462, and the value in the physical-page field of the entry containing the virtual-memory-address translation, as indicated by arrow 1464, to generate a physical-memory address corresponding to the virtual-memory address. The physical-memory address is then used, by the processor, to access the physical-memory word corresponding to the virtual-memory address in the load or store instruction.

However, when a valid virtual-memory-address translation is not found by the processor in the translation-lookaside buffer, the processor then undertakes a search for a translation in a page table. FIG. 14D illustrates the page-table search employed by a processor when a translation for a virtual-memory address cannot be found in the translation-lookaside buffer. An identifier for the currently executing process 1470 and the virtual-page address that is to be translated 1472 are used to search a page table 1474 for an entry containing a translation for the virtual-page address. The page table is often organized as a tree to facilitate rapid searching. The outcome of the search of the page table is either finding a valid translation for the virtual-page address, generation of a page fault indicating that the virtual-memory address is invalid, or generation of the page fault that indicates that the virtual-memory page needs to be read into physical memory from a mass-storage device. In the first case, the valid translation is entered into the translation-lookaside buffer. In the third case, the virtual-memory page is located in the mass-storage device and read into a physical-memory page, with a translation then generated and stored in the translation-lookaside buffer. When a translation is entered into the translation-lookaside buffer, a valid translation may be displaced and when a virtual-memory page is read into physical memory from a mass-storage device, a valid different virtual-memory page may be displaced from physical memory. Thus, the contents of the translation-lookaside buffer and page tables, as well as physical memory, are constantly changing in order to provide the illusion of separate address spaces for each process.

FIGS. 11-14D, discussed above, provide a brief overview of time-division multiplexing by operating systems and the basic hardware support for execution of processes provided by processors. There are many different implementations of processors and operating systems, and the instruction-set architectures, virtual-memory architectures, call-stack conventions, and other details discussed above may vary substantially from one implementation to another. The discussion of FIGS. 11-14D is provided, using specific examples, as an illustration of certain basic concepts rather than as a teaching or discussion of any particular operating-system or processor implementation.

### Currently Disclosed Methods and Systems

FIGS. 15A-D illustrates system-call execution by an operating system and underlying hardware in response to a system call made by an application. The system call is a routine call that requests execution of an operating-system routine. Execution of a system call is illustrated in FIG. 15A, using illustration conventions previously introduced with respect to FIGS. 11 and 13. Horizontal line segment 1502 represents execution of an application program. Call-stack representation 1504 represents a call-stack snapshot during execution of the application. At a point in time 1506, a currently executing application process or thread makes a call to an operating-system routine. Initially, a user-mode system-call-wrapper routine is called by the processor or thread, which results in a call frame for the user-mode system-call-wrapper routine pushed onto the call stack, as shown in snapshot representation 1508. The user-mode system-call-wrapper routine then generates a software interrupt, which results in execution of a kernel-mode handler, represented in FIG. 15A by vertical dashed line 1509 and horizontal line segment 1510. The kernel-mode handler runs at higher priority than the application and searches a system-call dispatch table 1512 to find the address for the called system routine and then calls that routine to execute the system call at the point in time 1512. In many implementations, execution of the system call does not involve a full context switch but, instead, the kernel-mode routine executes using the same call stack used by the application process or thread. In certain implementations, the interrupt generated by the user-mode system-call-wrapper routine is dispatched to an appropriate kernel-mode handler via an interrupt-dispatch table 1514. Call-stack snapshots 1516-1517 illustrate the fact that the kernel-mode routine is associated with a call frame that has been pushed onto the call stack. Once the kernel-mode routine completes execution, the call frame for the kernel-mode routine is popped from the call stack, the execution priority is lowered it back to application-level priority, and the user-mode system-call-wrapper routine resumes execution, as represented by horizontal line segment 1518. The user-mode system-call-wrapper routine completes execution, popping the call frame for the user-mode system-call-wrapper routine and resuming execution of the application process or thread, as represented by horizontal line segment 1520. The call-stack snapshot 1522 at the point in time that the application process or thread resumes execution is identical to the call-stack snapshot 1504 prior to the system call. Like the discussion of FIGS. 11-14B, the discussion of FIG. 15A is meant to provide a conceptual overview of system calls rather than specific details for specific operating-system and hardware implementations. Different operating systems and processors may use different approaches to implement system-call execution.

The system-call execution process includes many vulnerabilities to attacks by malicious entities seeking to reach the security of the computer system in which system calls are made. As one well-known example, a malicious entity might employ hacking techniques to change the routine addresses contained in the system-call dispatch table 1512 to redirect system calls to maliciously introduced routines or to corrupted routines, so that applications end up calling the maliciously introduced routines and corrupted routines rather than the original operating-system routines. This allows the malicious entities to execute kernel-mode functionality that can completely defeat security measures undertaken to secure data and system operation within the computer system. Maliciously introduced routines and corrupted routines, for example, may search the computer system for confidential information, such as credit-card and bank-account information and report back the confidential information to malicious entities. Maliciously introduced routines and corrupted routines may also delete or corrupt data and routines within the computer system and even crash the computer system and/or render the computer system inoperable. While system-call-dispatch-table corruption is a well-known example, and while many operating systems seek to protect system-call-dispatch tables from unauthorized access via memory-protection schemes, there are many additional aspects of the system-call execution process that may be attacked, including contents of the interrupt-dispatch table, the system-call-wrapper routines, and many other such aspects of the system-call execution process. In addition, even the memory protections applied to the system-call dispatch table may be overcome by malicious entities. Thus, the system-call execution process represents an entire set of security vulnerabilities that can be, and that have been, used by malicious entities to breach computer-system security and to corrupt computer-system integrity. These are serious vulnerabilities for which developers, manufacturers, vendors, and users of computer systems continue to seek remediation. In particular, detection of system-call-process corruptions is particularly difficult, particularly in an operational computer system. Only when such corruption has been detected can a system be repaired and restored to a secure state. It is detection, rather than amelioration, that poses the greatest challenges. The currently disclosed automated system-call-integrity monitor was developed to address the critical problem.

FIG. 15B shows a series of call-stack snapshots taken at each of a series of time points during execution of a system call. The first snapshot 1530 is taken immediately after the kernel-mode system routine first begins to execute. The frame-pointer register points to the return address in the call frame for the user-mode system-call-wrapper routine and the stack-pointer register contains the address of, or points to, the first available word on the call stack. In FIG. 15B, a curly-bracket-like indication is shown to the left of the call-stack snapshots to indicate the call frames. The call-stack snapshot 1532 taken at a next point in time reveals that the kernel-mode system routine has called a second kernel-mode routine, pushing a call frame onto the stack above a number of local variables pushed onto the stack by the kernel-mode system routine. These may be the current contents of registers that are subsequently used by the kernel-mode system routine following completion of the system call. The call frame for the second kernel-mode routine includes values for two arguments, the previous contents of the frame-pointer register, and the return address at which execution of the kernel-mode system routine will resume following completion of the second kernel-mode routine. The call-stack snapshot 1534 taken at a next point in time reveals that the second kernel-mode routine has pushed another call frame onto the call stack and called a third kernel-mode routine. The call-stack snapshot 1536 taken at a fourth point in time shows the contents of the call stack following completion of the third kernel-mode routine. The call-stack snapshot 1538 taken at a fifth point in time reveals that the second kernel-mode routine has called a fourth kernel-mode routine. The call-stack snapshot 1540 taken at a sixth point in time shows the contents of the call stack immediately following completion of execution of the fourth kernel-mode routine. The call-stack snapshot 1542 taken at a seventh point shows the contents of the call stack immediately preceding completion of execution of the kernel-mode system routine.

If call-stack snapshots are taken at a sufficient granularity in time during execution of a system call, the series of call-stack snapshots would show the entire sequence of internal kernel-mode-routine calls made by the kernel-mode system call. However, a subsequent execution of the system call is likely to generate a sequence of call-stack snapshots with different numeric values. Thus, the precise values stored in the call stack generally do not provide a reliable component of a reference fingerprint for the system call. However, if only the return addresses at the tops of the call frames are recorded in the snapshots, the sequence of snapshots are far more likely to together represent a reasonable component of a reference fingerprint for the particular system call from which they are generated. FIG. 15C shows the four unique return-address-only call-stack snapshots 1546-1549 generated from the call-stack snapshots shown in FIG. 15B. These four unique return-address-only call-stack snapshots can be more specifically represented by the single snapshot representation 1550. This representation indicates that any sequence or partial sequence of return addresses starting from the bottom return address 1552 and traversing the representation towards the top set of alternative return addresses 1554 constitutes a call-stack trace that might be observed in a snapshot taken of the call stack during execution of the kernel-mode system routine.

FIG. 15D shows the most general, concise representation of a set of observed call-stack traces recorded sequentially in time. A sequentially-ordered set of observed call-stack traces 1560-1574 generated during execution of a particular system call is shown at the top of FIG. 15D. In this representation, the different return addresses at the top of the call frames in the stack are represented by different small integers. All of these call-stack traces can be represented succinctly by an acyclic graph, or tree. The tree can be shown in an orientation 1572 with the root node 1574 at the bottom of the tree and can also be shown in an orientation 1576 with the root node 1574 at the top of the tree. Any sequence of return-address values in one of the call-stack traces occurs as a partial or full traversal path in the tree. For example, call-stack trace 1560 occurs in the tree by starting at the root node 1574 and discontinuing the traversal of that point. Call-stack trace 1561 is obtained by starting at the root node 1574 and then traversing downward and to the left to note 1578, where the traversal ends. As yet another example, call-stack trace 1565 is obtained by starting at the root node 1574, traversing downward to note 1578, then traversing downward to node 1580, then traversing downward to node 1582, and finally traversing to leaf node 1584. Were a system call to be executed many times, and were call-stack snapshots to be generated at random points in time for each system call, the call-stack snapshots could be automatically transformed into a tree-like representation that could serve as a reliable component of a reference fingerprint for the system call, since the pattern of internal routine calls and the address of the kernel-mode system routine is uniquely characteristic of each different system call supported by an operating system. Of course, many other fingerprints can be generated by many other techniques from the call-stack snapshots collected from many executions of a particular system call, with the tree-like representation discussed with reference to FIG. 15D being only one of many possible fingerprints.

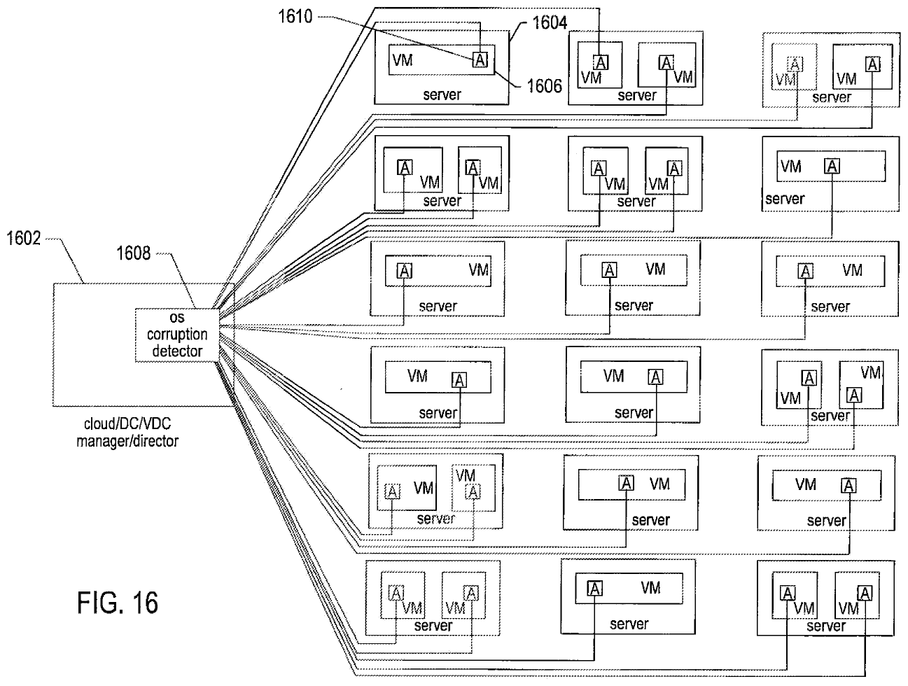

FIG. 16 illustrates, at a high level, one implementation of the currently disclosed automated system-call integrity-monitoring systems that monitor the system-call integrity of guest operating systems running in virtual machines of a distributed computer system in order to detect various types of corruptions and alterations of the system-call process carried out by the guest operating systems. In FIG. 16, the distributed computer system is represented by a management system 1602, such as a cloud-computing-facility manager or director, a data-center manager or director, or a virtual-data-center manager or director, and multiple server computers, such as server computer 1604, that each includes one or more virtual machines, such as virtual machine 1606. The implementation of the system-call-integrity monitor includes an operating-system-corruption detector (“detector”) 1608 subsystem or component within the manager/director 1602 and a system-call-integrity-monitor agent (“agent”), such as agent 1610 in virtual machine 1606 of server computer 1604, installed in, or associated with, each monitored virtual machine within the distributed computer system. The agent may be installed as a component of the guest operating system within a virtual machine or within a virtualization layer supporting execution of the virtual machine. The detector is responsible for maintaining a reference system-call fingerprint for each system call supported by each guest operating system within each monitored virtual machine and for randomly requesting and receiving operational fingerprints from monitored virtual machines and comparing the received operational fingerprints to the corresponding reference fingerprints in order to detect possible corruptions of the system-call processes of the guest operating systems within the monitored virtual machines. An operational fingerprint is generated by an agent in response to a system-call execution request received from the detector. A reference fingerprint for a system call is generated or received by the detector and stored by the detector as a representation of the operational fingerprints that can be generated by an agent within, or associated with, a virtual machine running an uncorrupted guest operating system. Upon detecting a potential guest-operating-system corruption, the detector raises an alert or alarm or generates another type of notification to inform the manager/director of the potential corruption. The manager/director can then either attempt to automatically verify and remediate the potential corruption or attempt to verify and characterize a potential corruption, as far as possible, before alerting a human administrator or manager of the distributed computer system to undertake remedial actions. The detector is thus a system-call-integrity monitor and provides a critical monitoring service for the distributed computer system in order to detect and ameliorate a large number of different possible security attacks related to the system-call process that, if left undetected, can result in serious security breaches, loss of confidential information, system corruption, system failure, and a recoverable system destruction.

An important feature of the currently disclosed automated system-call integrity-monitoring systems is that they do not rely on memory-protection mechanisms or analysis of in-memory executables and data stored in memory or mass storage to detect operating-system corruption, but instead detect operating-system corruption based on the operational behavior of an operating system. The currently disclosed automated system-call integrity-monitoring systems can therefore detect corruptions of types previously unobserved and unimagined by security experts, and can do so quickly and efficiently without large computational overheads and temporal delays.

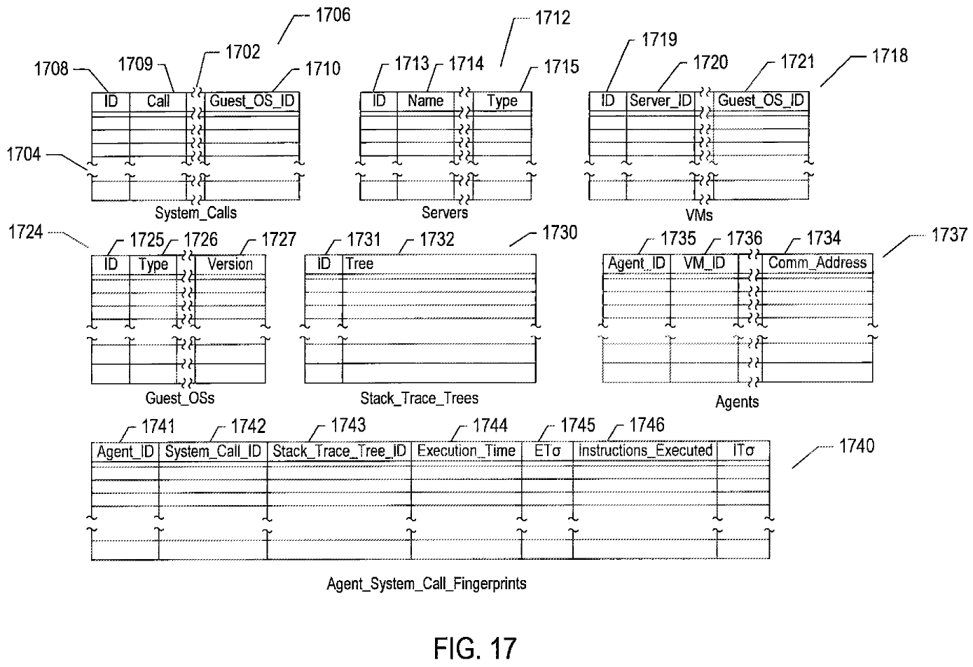

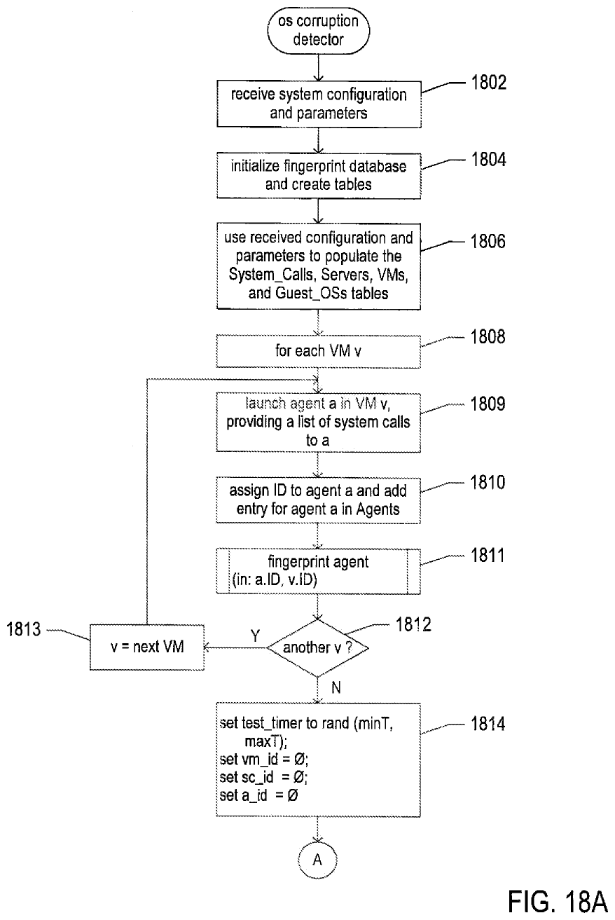

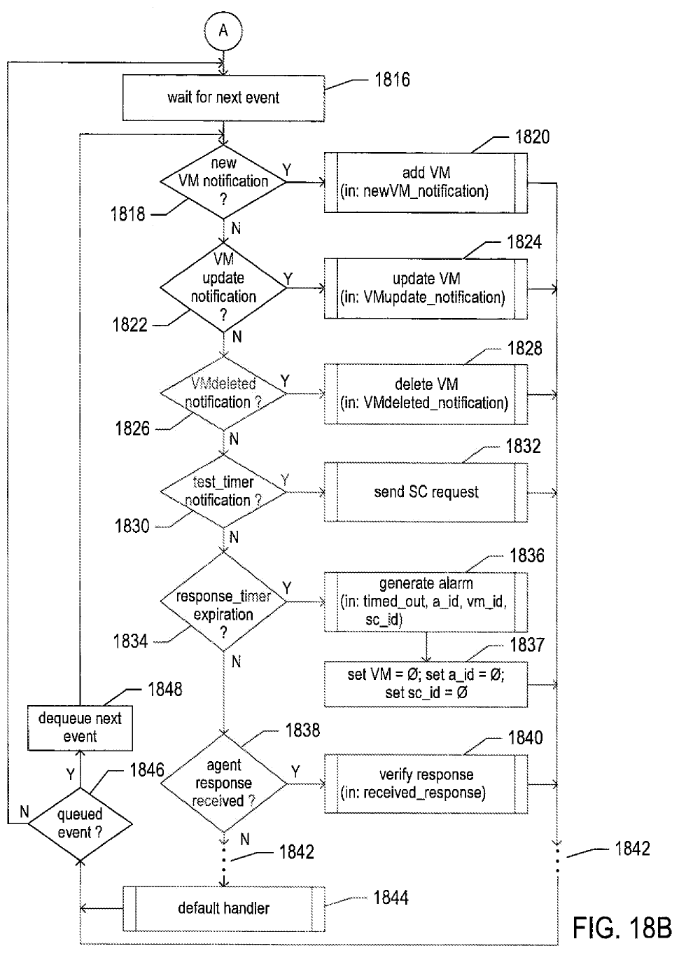

FIG. 17 shows a number of relational-database tables that are employed in control-flow diagrams, provided in FIGS. 18A-27, that illustrate one implementation of the currently disclosed automated system-call-integrity monitor. Of course, the data used by the routines that implement the system-call-integrity monitor may alternatively be stored by other means, including in flat files, indexed files, in-memory data structures, and other such data-storage methodologies. Relational-database tables are used for clarity and convenience in the following discussion. Broken columns, such as broken column 1702, and broken rows, such as broken row 1704, in FIG. 17 indicate the potential presence of additional columns and rows, respectively, in the illustrated tables. The rows in the relational-database tables are equivalent to records and the columns are equivalent to fields in the records.

The table System_Calls 1706 stores the selected system calls for each relevant guest operating system and each entry, or row, in the table includes the fields: (1) ID 1708, a unique identifier for each system call; (2) Call 1709, the text for the system call, including arguments; and (3) Guest_OS_ID 1710, the identifier for a guest operating system that uses the system call. The table Servers 1712 stores information about each of the servers in a distributed computer system and each entry, or row, in the table includes the fields: (1) ID 1713, a unique identifier for the server; (2) Name 1714, an alphanumeric server name; and (3) Type 1715, an indication of the type of server. The table VMs 1718 stores information about each virtual machine in the distributed computer system and each entry, or row, in the table includes the fields: (1) ID 1719, an identifier for the VM represented by the entry; (2) Server ID 1720, an identifier for the server in which the VM runs; and (3) Guest_OS_ID 1721, an identifier for the guest operating system running within the VM. The table Guest_OSs 1724 stores information about the guest operating systems in the distributed computer system and each entry, or row, in the table includes the fields: (1) ID 1725, an identifier for the guest operating system: (2) Type 1726, an indication of the type of the guest operating system; and (3) Version 1727, an indication of the version of the guest operating system. The table Stack_Trace_Trees 1730 stores stack-trace tree used to represent the possible call-stack traces that may be observed for one or more system calls, as discussed above with reference to FIG. 15D, and each entry, or row, in the table includes the fields: (1) ID 1731, an identifier for the stack-trace tree; and (2) Tree 1732, an encoding of the stack-trace tree. The table Agents 1734 stores information about each of the system-call-integrity-monitor agents and each entry, or row, in the table includes the fields: (1) Agent_ID 1735, an identifier for the agent represented by the entry: (2) VM_ID 1736, an identifier for the virtual machine associated with the agent; and (3) Comm_Address 1737, a communications address for the agent. The table Agent_System_Call_Fingerprints 1740 stores a reference fingerprint for each agent/system-call pair and each entry, or row, in the table includes the fields: (1) Agent_ID 1741, an identifier for an agent; (2) System_Call_ID 1742, the identifier for a system call; (3) Stack_Trace_Tree_ID 1743, the identifier of a stack-trace tree; (4) Execution_Time 1744, the average execution time for the agent/system-call pair; (5) ETσ 1745, the standard deviation of the observed execution times for the agent system-call pair: (6) Instructions_Executed 1746, the average number of instructions executed for an execution of the agent/system-call pair; and (7) IEσ, the standard deviation for the observed number-of-instructions values for the agent/system-call pair.

In the example implementation, a reference fingerprint for an agent/system-call pair includes a stack-trace tree representing the possible call-stack traces that can be observed during execution of the system call by the VM/guest-operating-system pair corresponding to an agent, an average observed average execution time for the system call along with the standard deviation for the average execution time, and an average number of instructions executed for the system call along with a standard deviation for the observed number of executed instructions. In this implementation, the standard deviations are included because the exact number of instructions executed for system call and the execution time for system call may vary from one execution of the system call to another, and the reference fingerprint therefore needs to characterize the observed distributions rather than simply use average values.

FIGS. 18A-B show a control-flow diagram for a routine “OS Corruption Detector,” which represents one implementation of the detector portion of the currently disclosed automated system-call-integrity monitor. In step 1802, the routine “OS Corruption Detector” receives configuration information for a distributed computer system and various operational-parameter values. In step 1804, the routine “OS Corruption Detector” initializes the database, discussed above with reference to FIG. 17, and creates the various tables shown in FIG. 17. In step 1806, the routine “OS Corruption Detector” uses the received configuration information and parameters to populate various of the database tables, including the tables System_Calls, Servers, VMs, and Guest_OSs tables. In the for-loop of steps 1808-1813, an agent is launched in each virtual machine, or associated with each virtual machine, to be monitored and is provided with a list of selected system calls used to generate operational fingerprints. An identifier is assigned to agent and an entry for the agent is added to the table Agents. In step 1811, a routine “fingerprint agent” is called to generate a reference fingerprint for each system call in the set of selected system calls executed by the agent to generate operational fingerprints. Each reference fingerprint is stored in the table Agent_System_Call_Fingerprints. Following completion of the for-loop of steps 1808-1813, the routine “OS Corruption Detector,” in step 1814, sets a timer test_timer to expire at a randomly selected future time point within a parameterized time window and sets local variables vm_id, sc_id, and a_id to 0. These variables are subsequently used to store the identifiers for a virtual machine, system call, and agent to which a system-call-execution request has been sent, as further discussed below. Then, turning to FIG. 18B, the routine “OS Corruption Detector” enters a continuous event-handling loop, in step 1816, where the routine “OS Corruption Detector” waits for the occurrence of a next event. When the next occurring event is receipt of a notification of a new virtual machine in the distributed computer system, as determined in step 1818, a handler “add VM” is called, in step 1820, to launch an agent in, or associated with, the new VM, assign an identifier to the agent, add an entry for the agent in the Agents table, and generate a reference fingerprint for each selected system call executed by the agent to generate operational fingerprints, as in steps 1809-1811 of FIG. 18A. Otherwise, when the next occurring event is notification of some type of update or alteration of a currently running virtual machine in the distributed computer system, as determined in step 1822, a handler “update VM” is called, in step 1824, to update information stored in the database for the virtual machine and agent running in, or associated with, the virtual machine. This may involve generating new reference fingerprints for the agent as well as updating information for the virtual machine in the table VMs. Otherwise, when the next occurring event is notification of the deletion or removal of a virtual machine from the distributed computer system, as determined in step 1826, a handler “deleteVM” is called, in step 1828, to accordingly update information in the database, including deleting entries for the VM and associated agent in the VMs and Agents tables. Otherwise, when the next occurring event is notification of expiration of the test_timer timer, as determined in step 1830, a routine “send SC request” is called, in step 1832, to send a next request to a randomly selected agent to generate an operational fingerprint of a randomly selected system call. When the next occurring event is expiration of a response timer, as the acted in step 1834, a routine “generate alarm” is called, in step 1836, to notify the manager/director hosting the system-call-integrity-monitor detector that an agent to which a request to generate an operational fingerprint was sent has failed to respond. The manager/director can then further investigate the problem and take any of various ameliorative actions. Otherwise, when the next occurring event is reception of a response to a request to execute a randomly selected system call and generate an operational fingerprint, as determined in step 1838, a handler “verify response” is called in step 1840. Ellipses 1842 indicate that various additional types of events may be handled by the event-handling loop of the system-call-integrity-monitor detector. A default handler is called, in step 1844, to handle any rare and/or unexpected events. Following handling of an event, the routine “OS Corruption Detector” determines, in step 1846, whether another event has been queued for handling. If so, a next event is dequeued, in step 1848, and control returns to step 1818 for handling of the next event. Otherwise, control returns to step 1816, where the routine “OS Corruption Detector” waits for the occurrence of a next event.

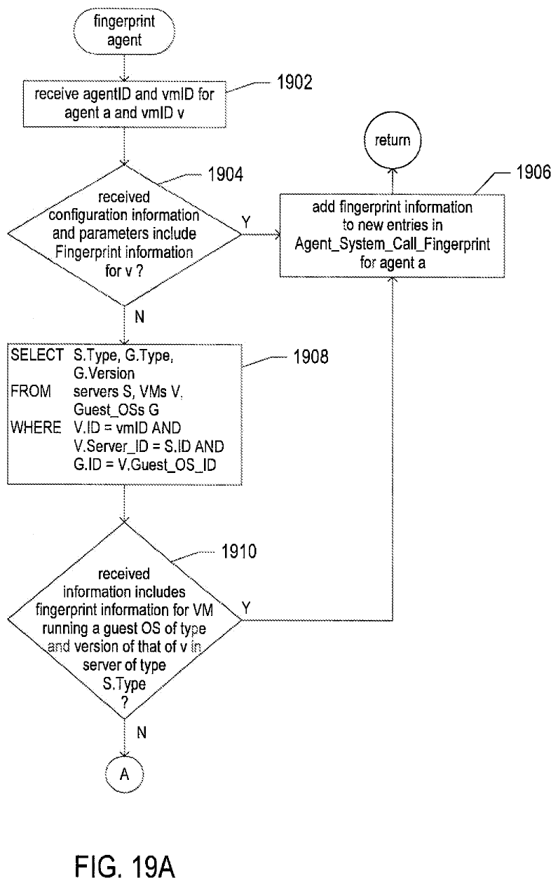

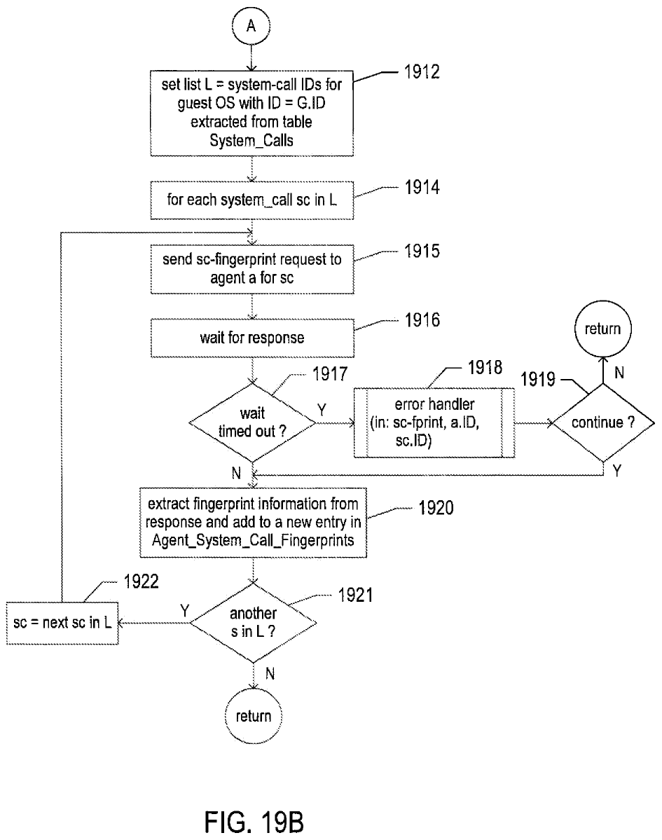

FIGS. 19A-B shows control-flow diagrams for the routine “fingerprint agent,” called in step 1811 of FIG. 18A. In step 1902, the routine “fingerprint agent” receives an agent identifier and a VM identifier as arguments. When the configuration and parameter information received by the routine “OS Corruption Detector,” considered to be accessible to the routine “fingerprint agent,” includes fingerprint information for the virtual machine identified by the received VM identifier, as determined in step 1904, that information is added in new entries to the table Agent_System_Call_Fingerprints, in step 1906. In certain cases, reference fingerprints are available for the set of system calls for operational-fingerprint generation for the guest-operating-system/virtual-machine pair. The reference fingerprints may have been generated, for example, from previously accumulated operational fingerprints generated by the guest-operating-system/virtual-machine pair. Otherwise, the server type, type of guest operating system, and guest-operating-system version are extracted from the database using the structured query language (“SQL”) statement shown in step 1908. The SQL statement is provided as an example of how queries are used to extract needed information from the database. SQL queries are not subsequently shown for information extraction in the control-flow diagrams.

When the configuration and parameter information received by the routine “OS Corruption Detector” includes fingerprint information for the server-type/guest-operating-system-type/guest-operating-system-version triple corresponding to the agent/virtual-machine pair identified by the received identifiers, as determined in step 1910, control flows to step 1906 where the reference fingerprint information is added to a new entry in the table Agent_System_Call_Fingerprints. The reference fingerprint information may have been derived from previous observations or from knowledge of the implementation of the system calls in the particular guest operating system. Otherwise, turning to FIG. 19B, the routine “fingerprint agent” generates reference fingerprints for each system call in the set of selected system calls for the guest operating system running in the virtual machine identified by the received VM identifier. In step 1912, the routine “fingerprint agent” sets a list L to contain the system-call identifiers for the guest operating system extracted from the table System_Calls. Then, in the for-loop of steps 1914-1922, the routine “fingerprint agent” considers each system call in the list L, sending a system-call fingerprint request, in step 1915, to the agent identified by the received agent identifier for the currently considered system call in list L. In step 1916, the routine “fingerprint agent” waits for a response from the agent. If the wait times out, as determined in step 1917, an error handler is called, in step 1918. Following completion of execution of the error handler, if the error represented by the timeout was ameliorated and the routine “fingerprint agent” is able to continue, as determined in step 1919, control flows to step 1920. Otherwise, the routine “fingerprint agent” returns. When a response has been received from the agent then, in step 1920, fingerprint information is extracted from the response and added to a new entry in the table Agent_System_Call_Fingerprints. When there is another system call in the list L, as determined in step 1921, the next system call is extracted from the list and control returns to step 1915. Otherwise, the routine “fingerprint agent” returns.

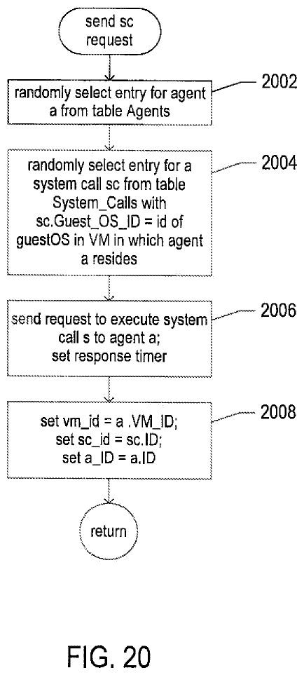

FIG. 20 provides a control-flow diagram for the routine “send SC request,” called in step 1832 of FIG. 18B. In step 2002, the routine “send SC request” randomly selects an entry for an agent a from the table Agents. In step 2004, the routine “send SC request” randomly selects an entry for a system call sc from the table System_Calls where the selected system call sc is associated with the type of guest operating system running in the virtual machine associated with agent a. In step 2006, the routine “send SC request” sends a request to the agent to execute the system call and sets the response timer. Finally, in step 2008, the routine “send SC request” sets local variables vm_id, sc_id, and a_id to the identifier for the VM associated with the randomly selected agent a, the identifier for the randomly selected system call sc, and the identifier for agent a, respectively.

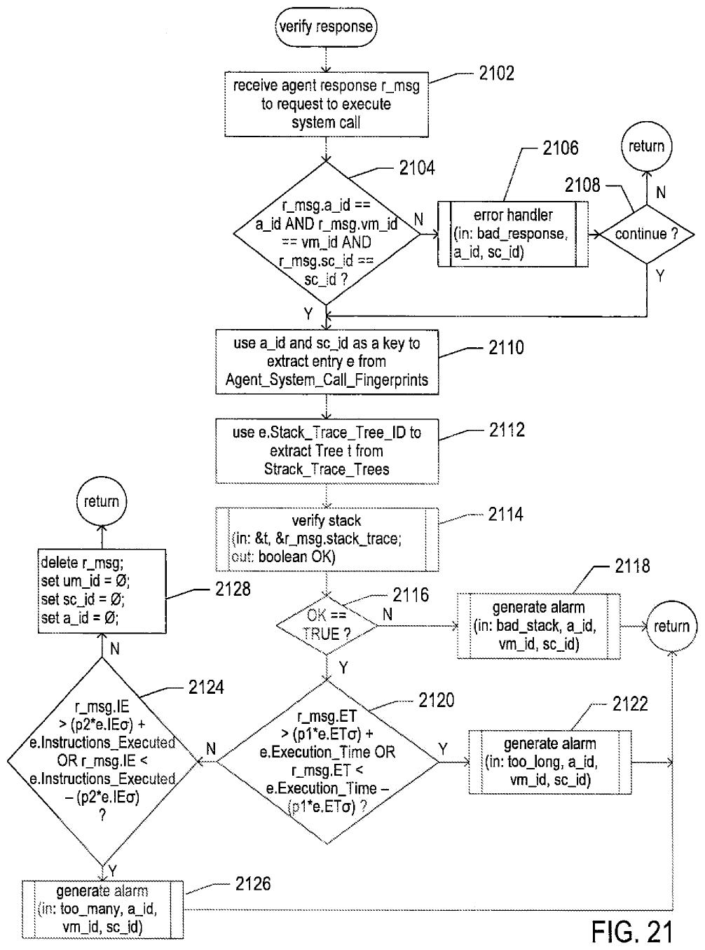

FIG. 21 provides a control-flow diagram for the routine “verify response,” called in step 1840 of FIG. 18B. This routine determines whether or not an operational fingerprint for a particular system call returned to the detector by an agent is compatible with the reference fingerprint for the particular system call maintained by the detector. An operational fingerprint is compatible with a corresponding reference fingerprint when values of components of the operational fingerprint fall into expected value ranges for the components specified by the reference fingerprint, as illustrated in the routine “verify response.” In step 2102, the routine “verify response” receives a response message r_msg sent by an agent in response to a request to execute a system call and generate an operational fingerprint. When the agent ID, VM_ID, and system-call ID in the response message are equal to the contents of the local variables a_id, vm_id, and sc_id, respectively, as determined in step 2104, control flows to step 2110. Otherwise, an error handler is called, in step 2106. Upon completion of the error handler, the routine “verify response” determines, in step 2108, whether it can continue. If not, the routine “verify response” returns. Otherwise, in step 2110, the contents of local variables a_id and sc_id are used as a key to extract an entry e from the table Agent_System_Call_Fingerprints. In Step 2112, the routine “verify response” uses the contents of the Stack_Trace_Tree_ID field of entry e to extract a stack-trace tree t from the table Stack_Trace_Trees. In step 2114, the routine “verify response” calls a routine “verify stack” to determine whether or not the call-stack trace included in the response message is a possible call-stack trace observable during execution of the system call identified by the identifier sc_id. When the call-stack trace is not a possible call-stack trace for the system call, as determined in step 2116, an alarm is generated, in step 2118, to notify the director/manager in which the system-call-integrity-monitor detector runs that a possible operating-system corruption has been detected, after which the routine “verify response” returns. Otherwise, when the observed execution time r_msg.ET is greater than (p1*e.ETσ)+e.Execution_Time or less than e.Execution_Time−(p1*e.ETσ), where p1 is a parameter, as determined in step 2120, an alarm is generated in step 2122, after which the routine “verify response” returns. In other words, the observed execution time included in the response message must fall within p1 standard deviations of the reference-fingerprint average execution time e.Execution_Time for the operational fingerprint returned in the response message to be considered equivalent to the reference fingerprint. Similarly, in step 2124, the routine “verify response” checks whether the observed number of instructions executed in executing the system call included in the response message falls within p2 standard deviations of the reference-fingerprint average number of instructions executed for the system call e.Instructions_Executed. If the observed number of instructions executed for the system call falls outside this range, an alarm is generated in step 2126. Otherwise, the operational fingerprint returned in the response message by the agent is verified as corresponding to the reference fingerprint and, in step 2128, the response message is deleted and local variables a_id, vm_id, and sc_id are all set to 0.

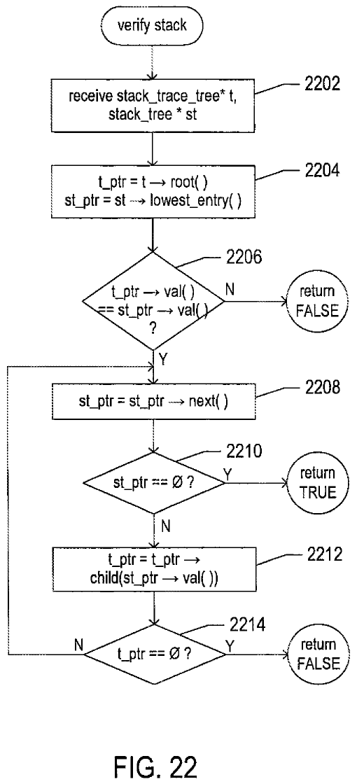

FIG. 22 provides a control-flow diagram for the routine “verify stack” called in step 2114 of FIG. 21. In step 2202, the routine “verify stack” receives a pointer to a stack-trace tree t and a pointer to a call-stack trace st. In step 2204, local variable t_ptr is set to point to the root node of the stack-trace tree referenced by t and local variable st_ptr is set to point to the lowest entry in the call-stack trace referenced by st. When the contents of the stack-trace-tree node pointed to by t_ptr, obtained via a call to the stack-trace-tree-node member function val, is not equal to the contents of the call-stack trace entry pointed to by st_ptr, obtained via a call to the stack-trace-entry member function val, as determined in step 2206, the routine “verify stack” returns the Boolean value FALSE. The first entry in the call-stack trace is required to contain the same return address as contained in the root node of the stack-trace tree. Otherwise, in step 2208, the pointer st_ptr is advanced to the next entry in the call-stack trace pointed to by st. If the pointer st_ptr is null, as determined in step 2210, then there are no further entries in the call-stack trace and, therefore, a path has been found within the stack-trace tree corresponding to the call-stack trace. The routine “verify stack” therefore returns the Boolean value TRUE. Otherwise, in step 2212, the routine “verify stack” attempts to set the pointer t_ptr to a child node of the stack-trace-tree node currently referenced by t_ptr containing a return address equal to the return address contained in the stack-trace entry referenced by pointer st_ptr via a call to a stack-trace-tree-node member function child. When t_ptr is set to a null value by this call, as determined in step 2214, the routine “verify stack” returns the value FALSE, since the stack-trace tree does not include a path equivalent to the contents of the call-stack trace. Otherwise, control returns to step 2208 to continue searching for a path within the stack-trace tree corresponding to the contents of the call-stack trace.

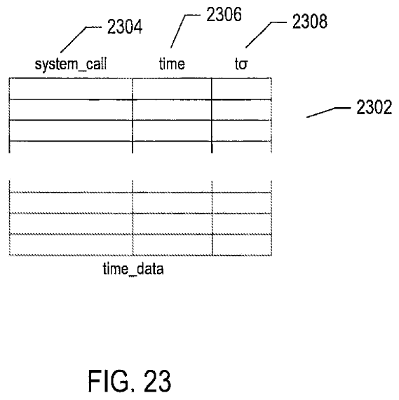

FIG. 23 shows a table time_data maintained by each system-call-integrity-monitor agent. Again, a relational database table is used, in this example, although the data contained in that table may be alternatively maintained in an in-memory data structure or in a file. The table time_data 2302 includes the following columns: (1) system_call 2304, which contains the text for the system call; (2) time 2306, which contains an average execution time for the system call; and tσ 2308, which contains the standard deviation for observed execution times. The average execution time and standard deviation for the system calls are forwarded to the agent by the detector or generated by the agent in response to a system-call fingerprints request received from the detector.

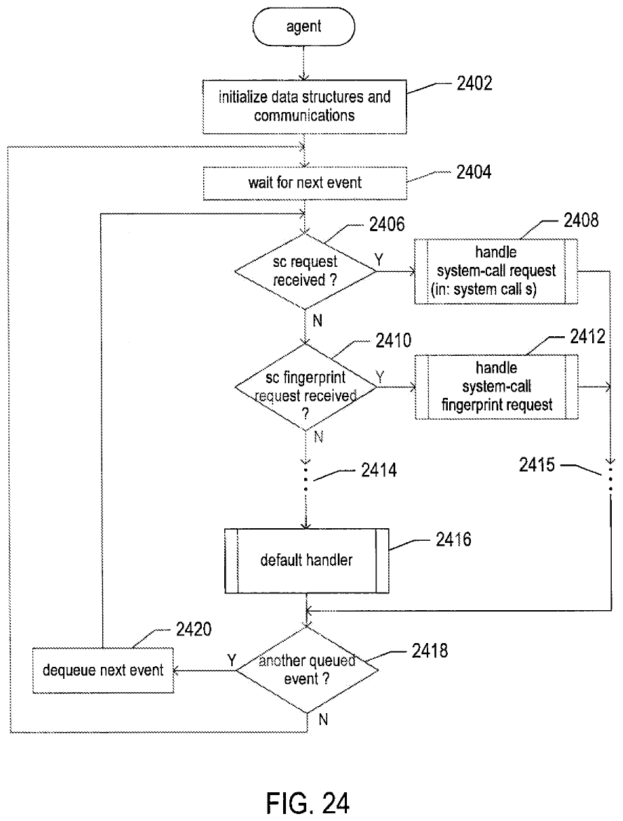

FIG. 24 provides a control-flow diagram for a routine “agent,” which represents the operation of each system-call-integrity-monitor agent. In step 2402, the routine “agent” initializes data structures, including the time-data table, and communications connections. In step 2404, the routine “agent” waits for the occurrence of the next event. When the next occurring event is a system-call request received from the detector, as determined in step 2406, a system-call-request handler is called in step 2408. Otherwise, when the next occurring event is reception of a system-call-fingerprint request from the detector, as determined in step 2410, a system-call fingerprint-request handler is called in step 2412. Ellipses 2414-2415 indicating that other types of events may be handled by the agent. A default handler 2416 handles any rare or unexpected events. Following handling of an event, the routine “agent” checks, in step 2418, whether there is another event queued for handling. If so, a next event is dequeued in step 2420 and control returns to step 2406. Otherwise, control returns to step 2404, where the routine “agent” waits for the occurrence of a next event.

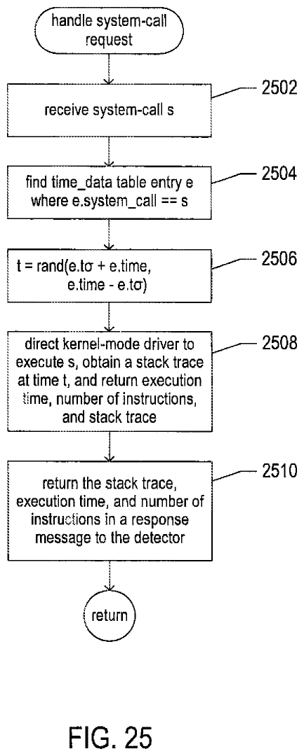

FIG. 25 provides a control-flow diagram for the system-call-request handler called in step 2408 of FIG. 24. In step 2502, the handler receives a system call s. In step 2504, the handler searches for an entry e in the table time_data for the system call s. In step 2506, the handler sets a time value t to a randomly selected time within a range of times within one standard deviation of the average time of execution of the system call. Finally, in step 2508, the handler directs a kernel-mode driver within the guest operating system of the virtual machine associated with the agent to execute the system call s. The handler also uses guest-operating-system functionality and/or virtualization-layer functionality to obtain a call-stack trace at time offset t from the beginning of execution of the system call as well as indications of the total time of execution of the system call and the number of instructions executed in order to execute the system call. The guest-operating-system or virtualization-layer functionality may employ underlying hardware performance-monitoring registers in order to obtain certain of this information. In step 2510, the collected information for the system call is returned in a response message to the detector. In this implementation, a single call-stack trace is generated during execution of the system call at or near a specified point in time. In other implementations, multiple call-stack traces may be generated, in which case they are all checked by an alternate version routine “verify response” shown in FIG. 21. In other implementations, no stack-trace snapshot time is specified.

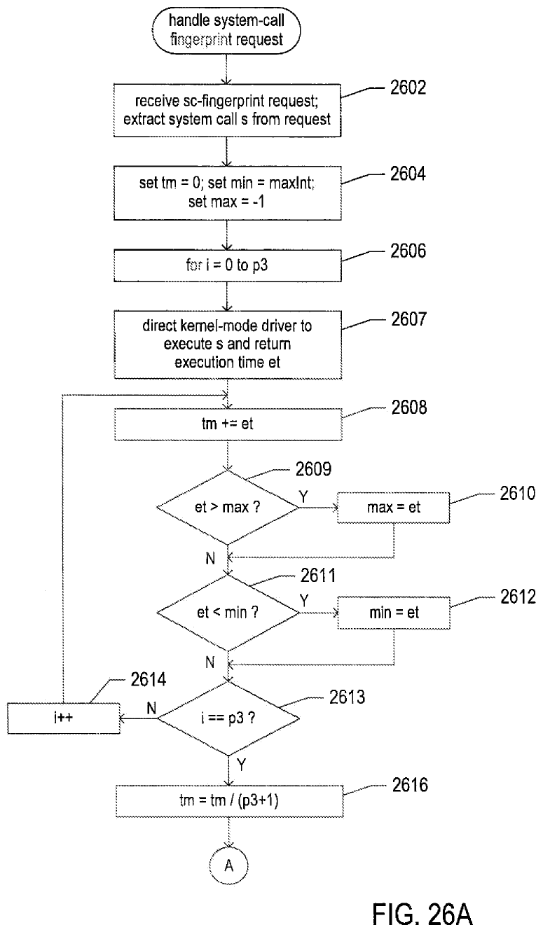

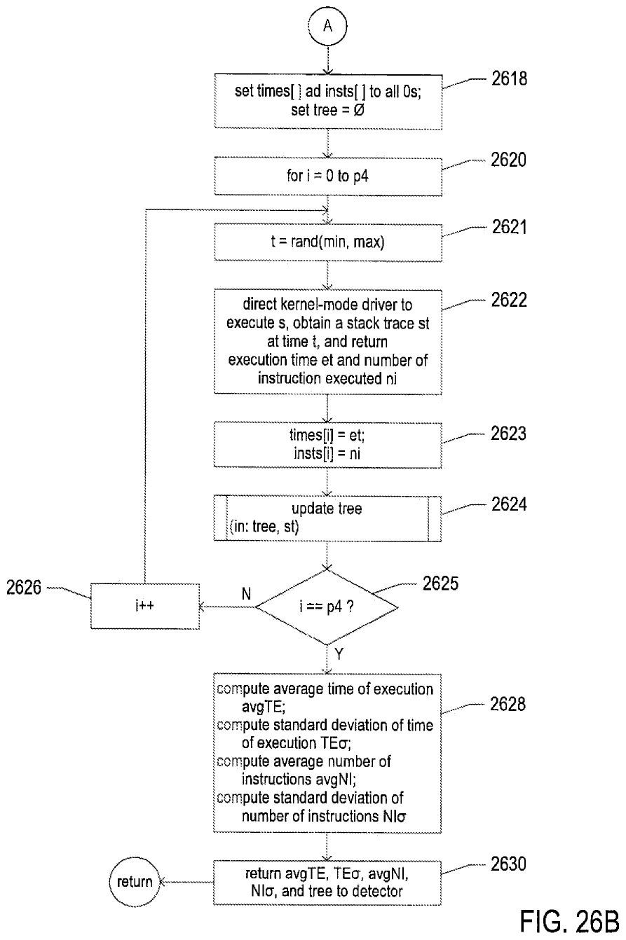

FIGS. 26A-B provide control-flow diagrams for the system-call-fingerprint-request handler called in step 2412 of FIG. 24. In step 2602, the handler receives the system-call-fingerprint request from the detector and extracts an indication of the system call s to fingerprint from the received request message. In step 2604, the handler sets local variable tm to 0, local variable min to a large integer maxInt, and sets local variable max to −1. Then, in the for-loop of steps 2606, the handler carries out p3 executions of the system call s in order to compute an estimated average time of execution of the system call, in step 2616. In each iteration of the for-loop of steps 2606-2614, the handler directs a kernel-mode driver associated with the guest operating system of the virtual machine associated with the agent to execute system call s and return the observed execution time et, in step 2607. The estimated execution time is added to local variable tm, in step 2608. When the observed execution time is greater than the contents of local variable max, as determined in step 2609, local variable max is updated to contain the observed execution time et in step 2610. Similarly, when the observed execution time is less than the contents of local variable min, as determined in step 2611, local variable min is set to the observed execution time et in step 2612. Turning to FIG. 26B, local arrays times and insts are set to contain all Os and a local stack-trace-tree variable tree is initialized to an empty stack-trace tree in step 2618. In the for-loop of steps 2620-2626, the handler launches p4 executions of the system call s by the kernel-mode driver, in step 2622. For each execution of the system call, the observed execution time and observed number of instructions are entered into the times and insts arrays, respectively, in step 2623. In step 2624, a routine “update tree” is called to update the stack-trace tree with the call-stack trace returned from execution of the system call in step 2622. Following completion of the for-loop of steps 2620-2626, the handler computes an observed average time of execution and standard deviation of execution time and an observed average number of instructions executed and a standard deviation of the observed numbers of instructions executed using the data collected in the arrays times and insts, in step 2628. These computed values and the stack-trace tree are returned in a response message to the detector, in step 2630.

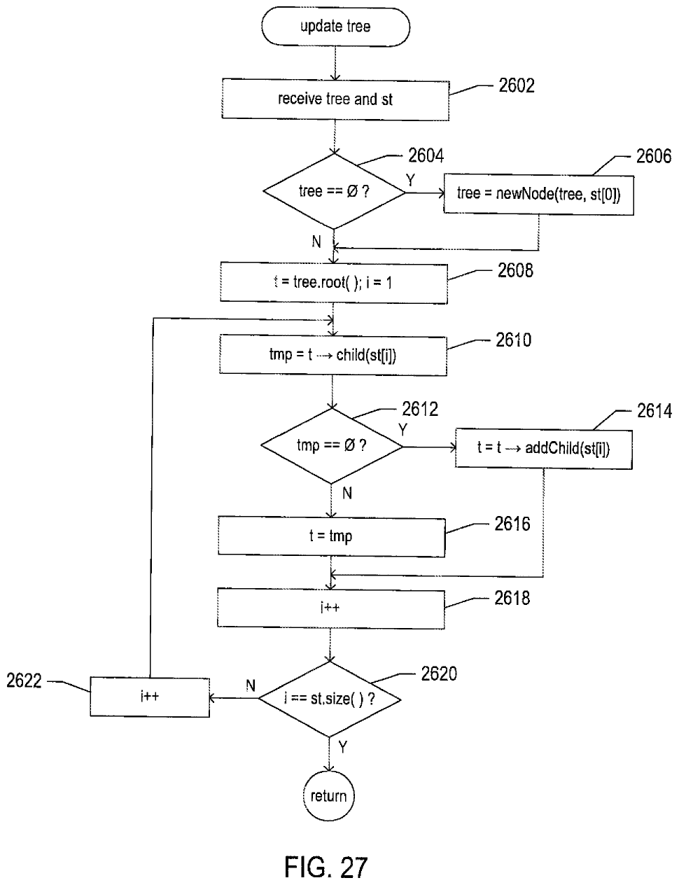

FIG. 27 provides a control-flow diagram for the routine “update tree” called in step 2624 of FIG. 26B. In step 2602, the routine “update tree” receives a stack-trace tree and a call-stack trace. When the received tree is an empty stack-trace tree, as determined in step 2604, a root node is added to the tree, the root node containing the return address in the lowest-level entry of the call-stack trace, in step 2606. In step 2608, the local variable t is set to point to the root node of the stack-trace tree and a loop variable i is set to 1. In step 2610, a local variable tmp is set to point to a child node of the stack-trace tree node referenced by local variable t that contains the return address contained in entry i of the call-stack trace. If tmp is set to a null value in step 2610, as determined in step 2612, then, in step 2614, a new node is added as a child node to the node referenced by local variable t, and local variable t is updated to point to the new child node. Otherwise, in step 2616, local variable t is set to the contents of local variable tmp. In step 2618, loop variable i is incremented. When the contents of local variable i is equal to the number of entries in the call-stack trace, as determined in step 2620, the routine “update tree” returns. Otherwise, in step 2622, loop variable i is incremented and control returns to step 2610.

Although the present invention has been described in terms of particular embodiments, it is not intended that the invention be limited to these embodiments. Modification within the spirit of the invention will be apparent to those skilled in the art. For example, any of a variety of different implementations of the guest-operating-system-corruption monitor can be obtained by varying any of many different design and implementation parameters, including modular organization, programming language, underlying operating system, control structures, data structures, and other such design and implementation parameters. As discussed above, there are many different possible alternative types of reference fingerprints and operational fingerprints that may be used by a system-call-integrity monitor. These alternative fingerprints may include additional metrics to those discussed above a container alternative metrics that together provide a robust fingerprint for each system call of a set of selected system calls used for monitoring. As mentioned above, an operational fingerprint may contain multiple call-stack traces, in certain implementations. In the described implementation, only return addresses are present in the call-stack trace, but, in alternative implementations, additional information may be included in call-stack traces. In the above-discussed implementation, the detector sends out only one request for system-call execution to one randomly selected agent at a time. However, in alternative implementations, the detector may send out multiple concurrent requests for system-call execution to multiple randomly selected agents and may process the responses returned from the agents in parallel. Of course, the frequency at which the detector sends requests for system-call executions to the agents is a parameter that may vary with different distributed-computer height and system configurations. Any of many different methods can be used by an agent for launching execution of a system call and collecting data during execution of the system call to construct an operational fingerprint for the system call. In a disclosed implementation, a kernel-mode driver is employed, but alternative approaches are possible. In the disclosed implementation, the proposed time offset for generation of the call-stack trace is included in the request for execution of the system call by the kernel-mode driver. However, in alternative implementations, the time offset for collection of the call-stack trace is not specified. While the currently disclosed automated system-call-integrity monitor operates within a distributed computer system, system-call-integrity monitors may alternatively be employed in discrete computer systems and non-distributed computer-system aggregates, including computer-system clusters. In the disclosed implementations, the arguments are specified for the system call, in the Call field of the table System_Calls. In alternative implementations, there may be multiple entries in the table System_Calls for a given system call, each entry including different arguments, so that different arguments are randomly selected for system-call execution by agents.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system-call-integrity monitor comprising:
an agent, implemented as a set of processor instructions that, when executed by one or more processors within a computer system that hosts the agent, control the computer system to
receive, from a detector, a request to execute a system call and generate an operational fingerprint for the system call,
launch execution of the system call by an operating system that runs within the computer system that hosts the agent,
generate the operational fingerprint from data related to execution of the system call, and
return the operational fingerprint to the detector in a response to the received request; and
the detector, implemented as a set of processor instructions that, when executed by one or more processors within a computer system that hosts the detector, control the computer system to
select a next monitoring time point, and
at the next monitoring time point,
randomly select a system call from a set of system calls used for system-call-integrity monitoring,
send a request to the agent to execute the randomly selected system call and generate an operational fingerprint for the randomly selected system call,
receive the operational fingerprint from the agent,
compare the operational fingerprint to a reference-fingerprint for the randomly selected system call, and
when the comparison indicates that the operational fingerprint is not compatible with the reference fingerprint, generate an alert, alarm, or other notification that a system-call process in the computer system that hosts the agent has been corrupted.

2. The system-call-integrity monitor of claim 1
wherein each system call of the set of system calls used for system-call-integrity monitoring is associated with a reference fingerprint that specifies a value range for each component of an operational fingerprint generated from data related to execution of the system call; and
wherein the generated operational fingerprint is compatible with the reference fingerprint for the randomly selected system call when the value of each operational-fingerprint component falls within the value range for the component specified in the reference fingerprint for the randomly selected system call.

3. The system-call-integrity monitor of claim 2 wherein the components of an operational fingerprint generated from data related to execution of a system call include:
an indication of the execution time for the system call;
an indication of the number of instructions executed in order to execute the system call; and
a call-stack trace taken during execution of the system call.

4. The system-call-integrity monitor of claim 3 wherein a reference fingerprint associated with a system call includes:
an indication of an average execution time computed from execution times for multiple executions of the system call;
an indication of the standard deviation of the execution times for multiple executions of the system call;
an indication of an average number of instructions executed in order to execute the system call computed from the numbers of instructions executed for multiple executions of the system call;
an indication of the standard deviation of the numbers of instructions executed for multiple executions of the system call; and
an indication of the different call-stack traces that can be taken during execution of the system call.

5. The system-call-integrity monitor of claim 4 wherein an operational fingerprint is compatible with a reference fingerprint when:
the operational fingerprint and the reference fingerprint are both associated with a single system call;
the indication of the execution time for the system call in the operational fingerprint is a value within a number of standard deviations from the value indicated by the indication of an average execution time in the reference fingerprint, where the number is a first parameter value and the value of the standard deviation is indicated by the indication of the standard deviation of the execution times in the reference fingerprint;
the indication of the number of instructions executed for the system call in the operational fingerprint is a value within a number of standard deviations from the value indicated by the indication the average number of instructions executed in order to execute the system call, where the number is a second parameter value and the value of the standard deviation is indicated by the indication of standard deviation of the numbers of instructions in the reference fingerprint; and
the call-stack trace in the operational fingerprint is one of the different call-stack traces that can be taken during execution of the system call indicated in the reference fingerprint.

6. The system-call-integrity monitor of claim 1 wherein the detector randomly selects the next monitoring time point from within a range of time points.

7. A system-call-integrity monitor incorporated into a distributed computer system having multiple computer systems, each computer system hosting one or more virtual machines that each provides an execution environment for a guest operating system, the system-call-integrity monitor comprising:
multiple agents, each agent implemented as a set of processor instructions that, when executed within a virtual machine, controls the virtual machine to
receive, from a detector, a request to execute a system call and generate an operational fingerprint for the system call,
launch execution of the system call by the guest operating system running within the virtual machine that provides an execution environment for the agent,
generate the operational fingerprint from data related to execution of the system call, and
return the operational fingerprint to the detector in a response to the received request; and
the detector, implemented as a set of processor instructions that, when executed by one or more processors within a computer system that hosts the detector, control the computer system to
select a next monitoring time point, and
at the next monitoring time point,
select an agent from among the multiple agents,
randomly select a system call from a set of system calls used for system-call-integrity monitoring of the virtual machine in which the selected agent runs,
send a request to the selected agent to execute the randomly selected system call and generate an operational fingerprint for the randomly selected system call,
receive the operational fingerprint from the selected agent,
compare the operational fingerprint to a reference-fingerprint for the randomly selected system call, and
when the comparison indicates that the operational fingerprint is not compatible with the reference fingerprint, generate an alert, alarm, or other notification that a system-call process in the virtual machine that runs the agent has been corrupted.

8. The system-call-integrity monitor of claim 7
wherein each system call of the set of system calls used for system-call-integrity monitoring of the virtual machine in which the selected agent runs is associated with a reference fingerprint that specifies a value range for each component of an operational fingerprint generated from data related to execution of the system call; and
wherein an operational fingerprint is compatible with a corresponding reference fingerprint when the value of each operational-fingerprint component falls within the value range for the component specified in the reference fingerprint.

9. The system-call-integrity monitor of claim 7 wherein an operational fingerprint generated from data related to execution of a system call includes:
an indication of the execution time for the system call;
an indication of the number of instructions executed in order to execute the system call; and
a call-stack trace taken during execution of the system call.

10. The system-call-integrity monitor of claim 9 wherein a reference fingerprint associated with a system call includes:
an indication of an average execution time computed from execution times for multiple executions of the system call;
an indication of the standard deviation of the execution times for multiple executions of the system call;
an indication of an average number of instructions executed in order to execute the system call computed from the numbers of instructions executed for multiple executions of the system call;
an indication of the standard deviation of the numbers of instructions executed for multiple executions of the system call; and
an indication of the different call-stack traces that can be taken during execution of the system call.

11. The system-call-integrity monitor of claim 10 wherein an operational fingerprint is compatible with a reference fingerprint when:
the operational fingerprint and the reference fingerprint are both associated with a single system call;
the indication of the execution time for the system call in the operational fingerprint is a value within a number of standard deviations from the value indicated by the indication of an average execution time in the reference fingerprint, where the number is a first parameter value and the value of the standard deviation is indicated by the indication of the standard deviation of the execution times in the reference fingerprint;
the indication of the number of instructions executed for the system call in the operational fingerprint is a value within a number of standard deviations from the value indicated by the indication the average number of instructions executed in order to execute the system call, where the number is a second parameter value and the value of the standard deviation is indicated by the indication of standard deviation of the numbers of instructions in the reference fingerprint; and
the call-stack trace in the operational fingerprint is one of the different call-stack traces that can be taken during execution of the system call indicated in the reference fingerprint.

12. The system-call-integrity monitor of claim 11 wherein the different call-stack traces that can be taken during execution of the system call are indicated in the reference fingerprint by an acyclic graph, each path starting from the root of which constitutes one of the different call-stack traces that can be taken during execution of the system call.

13. The system-call-integrity monitor of claim 7 wherein the detector randomly selects the next monitoring time point from within a range of time points.

14. The system-call-integrity monitor of claim 7 wherein the detector randomly selects an agent select an agent from among the multiple agents,

15. A method for detecting corruption of an operating system running within a computer system, the method comprising:
generating a set of system calls that can be executed by the operating system and that can be used to monitor the operating system for corruption;
receiving or generating, for each system call in the set of system calls, a reference fingerprint; and
for each of multiple randomly selected time points,
randomly selecting a system call from the set of system calls,
direct the operating system to execute the system call,
obtain data related to execution of the system call,
generate an operational fingerprint from the obtained data,
compare the operational fingerprint to the reference fingerprint associated with the selected system call, and
when the operational fingerprint is not compatible with the reference fingerprint, generating an alarm, alert, or other notification that a system-call process in the computer system has been corrupted.

16. The method of claim 15 wherein the operational fingerprint is compatible with the reference fingerprint when the value of each operational-fingerprint component falls within a value range for the component specified in the reference fingerprint.

17. The method of claim 15 wherein the operational fingerprint generated from data related to execution of a system call includes:
an indication of the execution time for the system call;
an indication of the number of instructions executed in order to execute the system call; and
a call-stack trace taken during execution of the system call.

18. The method of claim 15 wherein a reference fingerprint associated with a system call includes:
an indication of an average execution time computed from execution times for multiple executions of the system call;
an indication of the standard deviation of the execution times for multiple executions of the system call,
an indication of an average number of instructions executed in order to execute the system call computed from the numbers of instructions executed for multiple executions of the system call;
an indication of the standard deviation of the numbers of instructions executed for multiple executions of the system call; and
an indication of the different call-stack traces that can be taken during execution of the system call.

19. The method of claim 18 wherein an operational fingerprint is compatible with a reference fingerprint when:
the operational fingerprint and the reference fingerprint are both associated with a single system call;
the indication of the execution time for the system call in the operational fingerprint is a value within a number of standard deviations from the value indicated by the indication of an average execution time in the reference fingerprint, where the number is a first parameter value and the value of the standard deviation is indicated by the indication of the standard deviation of the execution times in the reference fingerprint;
the indication of the number of instructions executed for the system call in the operational fingerprint is a value within a number of standard deviations from the value indicated by the indication the average number of instructions executed in order to execute the system call, where the number is a second parameter value and the value of the standard deviation is indicated by the indication of standard deviation of the numbers of instructions in the reference fingerprint; and
the call-stack trace in the operational fingerprint is one of the different call-stack traces that can be taken during execution of the system call indicated in the reference fingerprint.

20. The method of claim 15 wherein the different call-stack traces that can be taken during execution of the system call are indicated in the reference fingerprint by an acyclic graph, each path starting from the root of which constitutes one of the different call-stack traces that can be taken during execution of the system call.
